(19) United States
(12) Patent Application Publication
(10) Pub. No.: US 2025/0086643 A1
(43) Pub. Date: Mar. 13, 2025

(54) PLATFORM TO SUPPORT MULTIPLE CLIENT ACCESS TO A REAL-TIME PAYMENT RAIL

(71) Applicant: FIDELITY INFORMATION SERVICES, LLC, Jacksonville, FL (US)

(72) Inventors: Jason WILLIAMS, Castle Rock, CO (US); Adrian STURLEY, Ponte Vedra, FL (US); Jeffry STAHLY, Spring Hill, TN (US); Patrick HAAS, San Francisco, CA (US); Manuela DRAGAN, Westfield, NJ (US)

(73) Assignee: FIDELITY INFORMATION SERVICES, LLC, Jacksonville, FL (US)

(21) Appl. No.: 18/946,301

(22) Filed: Nov. 13, 2024

Related U.S. Application Data
(63) Continuation of application No. 18/829,592, filed on Sep. 10, 2024.
(60) Provisional application No. 63/639,760, filed on Apr. 29, 2024.
(60) Provisional application No. 63/581,872, filed on Sep. 11, 2023.

(51) Int. Cl. G06Q 20/40

(52) U.S. Cl. CPC G06Q 20/407

(57) ABSTRACT

A method for payment transaction monitoring in a real-time payments system includes receiving a payment transaction; assigning an identifier to the payment transaction; associating an event with the identifier at each step of processing the payment transaction; recording the event with the identifier in real-time as the event occurs; monitoring the events in real-time to determine whether a payment transaction stop condition exists; and stopping processing of the payment transaction on a condition that the payment transaction stop condition exists.

### CROSS-REFERENCE TO RELATED APPLICATIONS

This application claims priority under 35 U.S.C. § 119 (e) to U.S. Provisional Patent Application No. 63/581,872, filed on Sep. 11, 2023 and U.S. Provisional Patent Application No. 63/639,760, filed on Apr. 29, 2024, the disclosures of which are expressly incorporated herein by reference in their entirety.

### BACKGROUND

Current electronic payment solutions face several significant challenges. Firstly, transactions are often slow to process and settle, leading to delays in funds availability. Additionally, the fee structures associated with electronic payment processing are frequently complex and can be costly for users. Daily transfer limits further restrict the flexibility of these systems.

Security concerns are also prevalent, with the risk of bad actors accessing the system and committing fraud. Human error is another factor that can result in transaction rejections, causing inconvenience and potential financial loss. Moreover, there is limited availability of various electronic payment types, such as different payment rails or schemes, which restricts user choice.

As payments become increasingly disconnected from accounts held at traditional financial institutions, users are seeking greater convenience, affordability, and security in their electronic payment transactions. This demand highlights the need for more versatile and user-friendly payment solutions that can meet the evolving needs of consumers and businesses alike.

### SUMMARY

A method for payment transaction monitoring in a real-time payments system includes receiving a payment transaction; assigning an identifier to the payment transaction; associating an event with the identifier at each step of processing the payment transaction; recording the event with the identifier in real-time as the event occurs; monitoring the events in real-time to determine whether a payment transaction stop condition exists; and stopping processing of the payment transaction on a condition that the payment transaction stop condition exists.

A method for routing a payment transaction in a real-time payments system includes receiving the payment transaction; examining contents of the payment transaction, wherein the contents of the payment transaction includes a transaction type; examining metadata associated with the payment transaction, wherein the metadata includes a payment rail preference; determining whether the payment transaction is formatted to match a format of the payment rail preference; reformatting the payment transaction to match the format of the payment rail preference on a condition that the payment transaction is not in the format of the payment rail preference; and routing the payment transaction to the payment rail for processing.

A method for repairing a payment transaction in a real-time payments system includes receiving the payment transaction; examining contents of the payment transaction, wherein the contents of the payment transaction includes a transaction type; examining metadata associated with the payment transaction, wherein the metadata includes a payment rail preference; repairing the payment transaction by examining an error code associated with the payment transaction and performing a repair operation on the payment transaction based on the error code; and routing the payment transaction to the payment rail for processing.

A method for processing a payment transaction in a real-time payments system includes receiving the payment transaction in a first format; reformatting the payment transaction into a second format; processing the payment transaction by the real-time payments system in the second format; reformatting the payment transaction into a third format; and sending the payment transaction in the third format to a payment rail for additional processing.

A real-time payments system includes an application programming interface endpoint component configured to receive a payment transaction; a payment orchestration component configured to process the payment transaction in the real-time payments system; a routing component configured to route the payment transaction from the real-time payments system to a payment rail to complete processing of the payment transaction; a repair component configured to implement a trained machine learning model to repair the payment transaction such that the payment transaction can continue to be processed by the payment orchestration component or by the payment rail; a data enrichment component configured to edit one or more elements of the payment transaction; and a reformatting component configured to reformat the payment transaction to a different format.

### BRIEF DESCRIPTION OF DRAWINGS

The accompanying drawings, which are incorporated in and constitute a part of this specification, illustrate several embodiments and, together with the description, serve to explain the disclosed principles. In the drawings:

FIG. 1 is a block diagram of an exemplary platform to implement a money management hub, consistent with disclosed embodiments.

FIG. 2 is a block diagram of an exemplary system architecture to implement the money management hub, consistent with disclosed embodiments.

FIG. 3 is a block diagram of a data enrichment component, consistent with disclosed embodiments.

FIG. 4 is a block diagram of data flows for real-time data delivery in the money management hub, consistent with disclosed embodiments.

FIG. 5 is a flow diagram of a payment orchestration method, consistent with disclosed embodiments.

FIG. 6 is a flow diagram of a payment orchestration process using machine learning, consistent with disclosed embodiments.

FIG. 7 is a flow diagram of a transaction monitoring process, consistent with disclosed embodiments.

FIG. 8 is a flow diagram of a transaction routing process between different entities, consistent with disclosed embodiments.

FIGS. 9A-9J are a flowchart of a method for processing an incoming send transaction, consistent with disclosed embodiments.

FIGS. 10A-10C are a flowchart of a method for processing an incoming send transaction between two hub member accounts, consistent with disclosed embodiments.

FIGS. 11A-11C are a flowchart of a method for processing an incoming receive transaction, consistent with disclosed embodiments.

### DETAILED DESCRIPTION

Reference will now be made in detail to exemplary embodiments, examples of which are illustrated in the accompanying drawings and disclosed herein. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting.

### Platform Overview

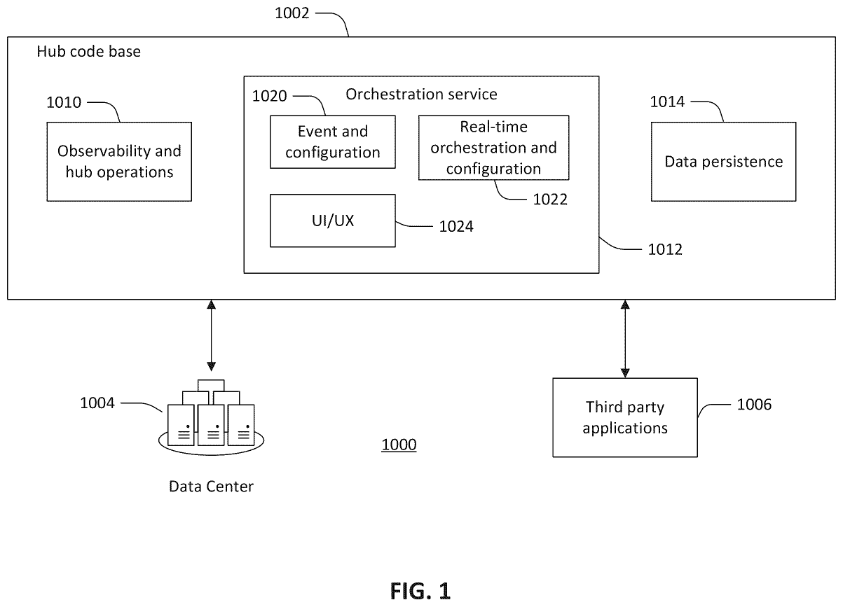

FIG. 1 is a block diagram of an exemplary platform 1000 to implement a money management hub (MMH), consistent with disclosed embodiments. In some embodiments, the MMH may be configured to support a wide range of payment types, including:
Person-to-Person Payments: This includes crowdfunding, digital wallet-to-digital wallet transfers, and gifts.
Business-to-Consumer Payments: Examples include merchant settlements, payroll and wage access, claims disbursements, rebate and voucher replacements, and other check replacements.
Business-to-Business Payments: This encompasses accounts receivable, accounts payable, and government payments.
Consumer-to-Business Payments: This covers physical point of sale purchases, e-commerce transactions, and bill payments.

While some disclosed embodiments relate to a real-time payments system, the MMH as described herein may also be configured to process payments that are not real-time settlement, such as Automated Clearing House (ACH) payments. The MMH may be configured to accommodate both an application programming interface (API) and files and may be configured to handle net settlement of payments as well as gross settlement of payments.

The platform 1000 includes a hub code base 1002 configured to communicate with a data center 1004 and third party applications 1006. It is noted that the platform 1000 may include additional components not shown in FIG. 1 without changing the overall operation of the platform 1000 as described herein. The data center 1004 may be configured to provide various data services for the platform 1000, including, but not limited to, data storage and access controls. The third party applications 1006 may be configured to interact with the MMH and to provide additional functionality beyond core MMH functions, as will be described herein. In some embodiments, the third party applications 1006 may be configured to provide additional services such as transaction fraud monitoring, know your customer (KYC) services, anti-money laundering (AML) services, functionality to enable embedded payments, and provide integration to clearing houses for real-time payments (RTP) and ACH.

The hub code base 1002 may include an observability and hub operations component 1010, an orchestration service 1012, and a data persistence component 1014. The hub code base 1002 may be configured to provide core functionality for the MMH, as will be described herein. The hub operations component 1010, the orchestration service 1012, and the data persistence component 1014 may be implemented as hardware, software, or a combination of hardware and software. While shown in FIG. 1 as being located in a single component (e.g., hub code base 1002), in some embodiments, the observability and hub operations component 1010, the orchestration service 1012, and the data persistence component 1014 may be located in separate components (e.g., separate servers) that may be configured to communicate with one another (e.g., by exchanging data).

The observability and hub operations component 1010 may be configured to support ingestion of all traces and metrics from the platform 1000. In some embodiments, the observability and hub operations component 1010 may be integrated with a framework to create and manage telemetry data, such as traces, metrics, and logs for the platform 1000. In some embodiments, the observability and hub operations component 1010 may also support exporting traces, metrics, and logs to an external observability dashboard, which may include a visualization component.

The orchestration service 1012 may be configured to expose APIs for integration with other systems of the platform 1000. In some embodiments, the orchestration service 1012 may be configured to provide payment initiation, payment validation, data enrichment, orchestration rules, and disbursement functions.

In some embodiments, the orchestration service 1012 may include an event and configuration component 1020, a real-time orchestration and configuration component 1022, and a user interface (UI)/user experience (UX) component 1024. The components 1020-1024 may be implemented as hardware, software, or a combination of hardware and software. While shown in FIG. 1 as being located in a single component (e.g., orchestration service 1012), in some embodiments, the components 1020-1024 may be located in separate components (e.g., separate servers) that may be configured to communicate with one another (e.g., by exchanging data).

The data persistence component 1014 may be configured to provide a real-time transaction store and data lake to assist with reporting, analytics, and reconciliation functions. In some embodiments, the data persistence component 1014 may also be configured to store business and technical metadata for the platform 1000.

### System Architecture

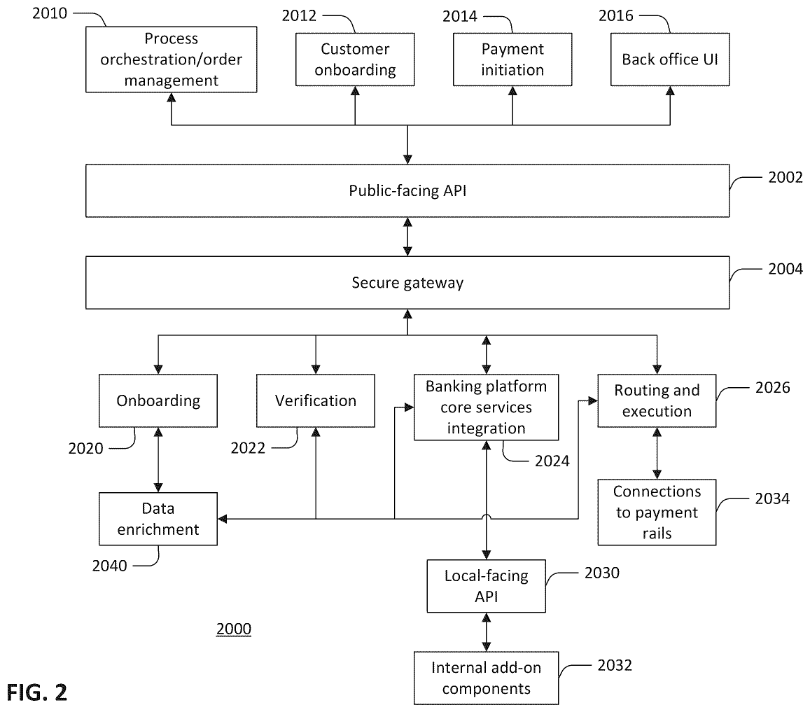

FIG. 2 is a block diagram of a system architecture 2000 to implement the money management hub (MMH), consistent with disclosed embodiments. The system architecture 2000 may include a public-facing application programming interface (API) 2002 which permits external components to access the MMH and a secure gateway 2004 in communication with the public-facing API 2002 and internal MMH components.

The public-facing API 2002 may be configured to enable developers to create connections between (e.g., communicate with) the MMH and various external components, such as process orchestration and order management component 2010, customer onboarding component 2012, payment initiation component 2014, and back office UI component 2016.

The process orchestration and order management component 2010 may be configured to automate a multistep workflow in the MMH and to coordinate movement of orders (e.g., a deposit or a credit) in the MMH.

The customer onboarding component 2012 may be configured to provide services to onboard a customer (e.g., an end user of a client that uses the MMH, such as a bank or a fintech) to enable access to the MMH. As used herein, the term “fintech” is used to indicate a non-bank financial technology company that may provide financial services to customers, for example, providing person-to-person money transfers.

The payment initiation component 2014 may be configured to initiate the steps of processing a payment in the MMH (e.g., starting the movement of money) and may include steps such as security checks (of both the sender and the recipient), account checks (e.g., whether the sender and receiver have the accounts indicated as being part of the transaction), and balance checks (e.g., whether the sender has sufficient funds to complete the transaction). The payment initiation component 2014 may also be configured to return payment status and events to the transaction initiator and to deliver account status updates, fraudulent activity warnings, and message responses to the bank or fintech that holds the account of the initiator.

Payment initiation may be provided via an API, via transaction files for items such as bulk real-time payments or Nacha (National Automated Clearing House Association) formatted ACH (Automated Clearing House) files (e.g., a file created from a corporate environment), or via direct initiation from a back office source.

The back office UI component 2016 may be configured to interact with various back office operations components, to provide general system maintenance data, metadata, traces, metrics, logs, or similar overall MMH system operations data. For example, the back office UI component 2016 may be configured to allow the MMH clients (e.g., banks, fintechs, corporations) to self-serve payment configuration, payment exceptions and repairs, fraud rule configuration, and access (e.g., view) dashboards on payment activity and system activity.

The secure gateway 2004 may be configured to provide various security features, including access control, security policies, and firewalls to control access to the features and functionality of the MMH. The secure gateway 2004 may be configured to communicate with various internal components, such as an onboarding component 2020, a verification component 2022, a banking platform core services integration component 2024, and a routing and execution component 2026. The banking platform core services integration component 2024 may be configured to communicate with a local-facing API 2030 to connect to various internal add-on components 2032. The routing and execution component 2026 may be configured to connect to various payment rails via connections 2034.

The onboarding component 2020 may be configured to provide services to add clients to access the MMH, such as banks or fintechs. The features of the onboarding component 2020 may include know your customer (KYC), know your business (KYB), providing terms and conditions agreements, and providing external account verification. In some embodiments, the onboarding component 2020 may be configured to communicate with the customer onboarding component 2012 via the secure gateway 2004 and the public-facing API 2002 to provide one or more onboarding services.

The verification component 2022 may be configured to provide services to verify potential clients prior to accessing the MMH. The features of the verification component 2022 may include legal and compliance testing, fraud detection, anti-money laundering (AML), Office of Foreign Assets Control (OFAC) compliance, and Financial Action Task Force (FATF) special recommendation (SR) and Suspicious Activity Report (SAR) reporting.

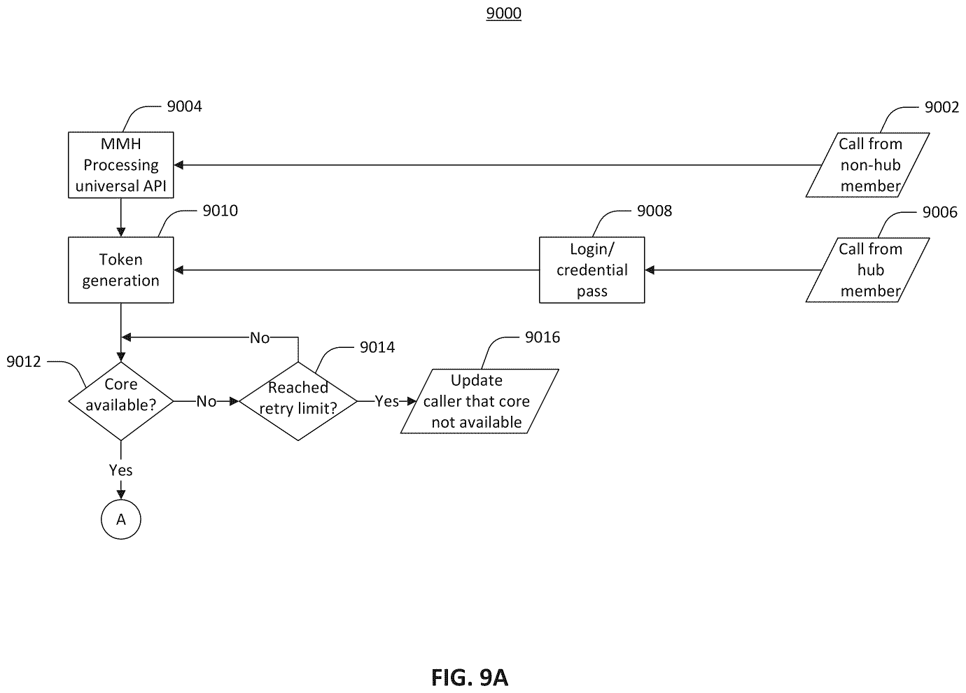

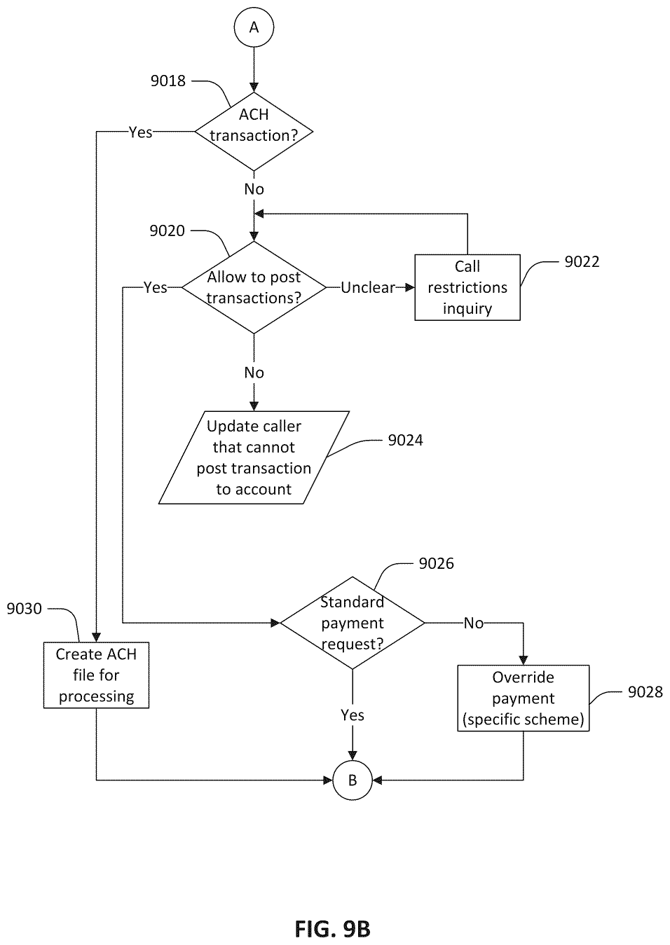

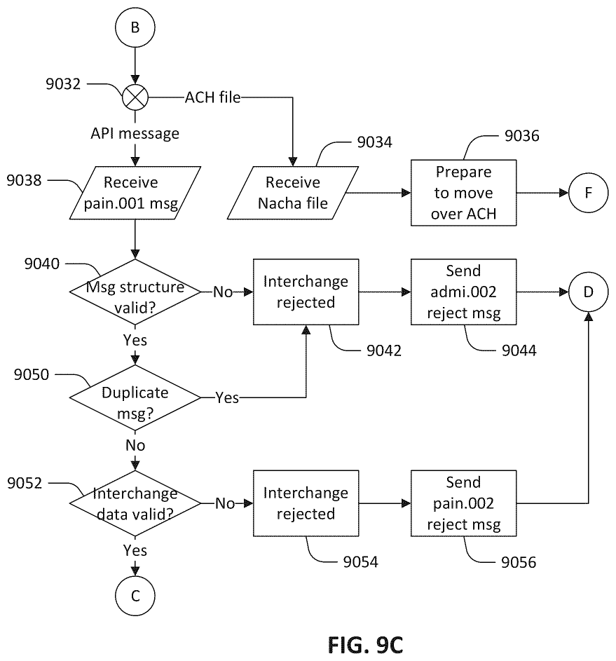

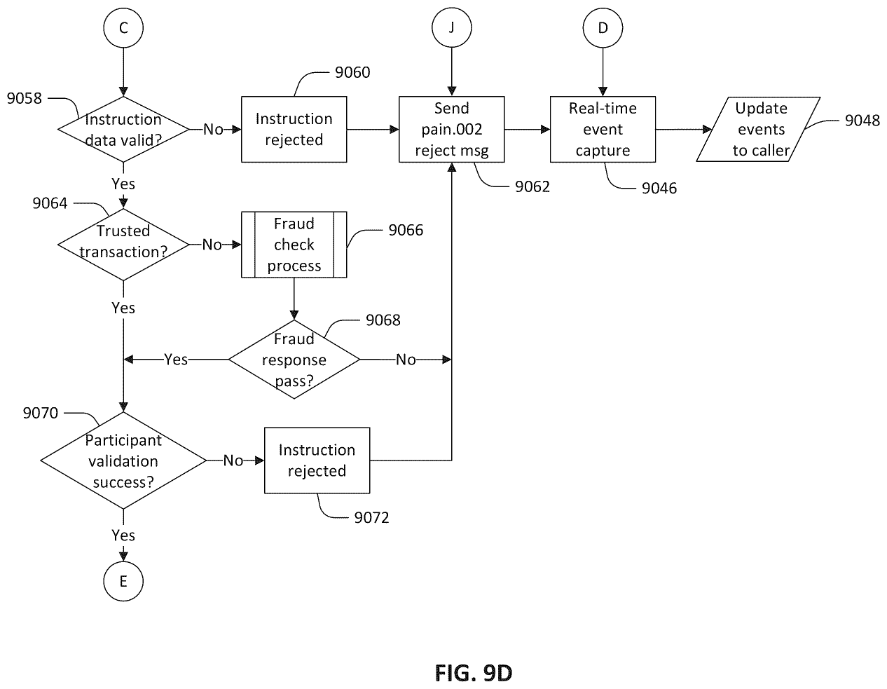

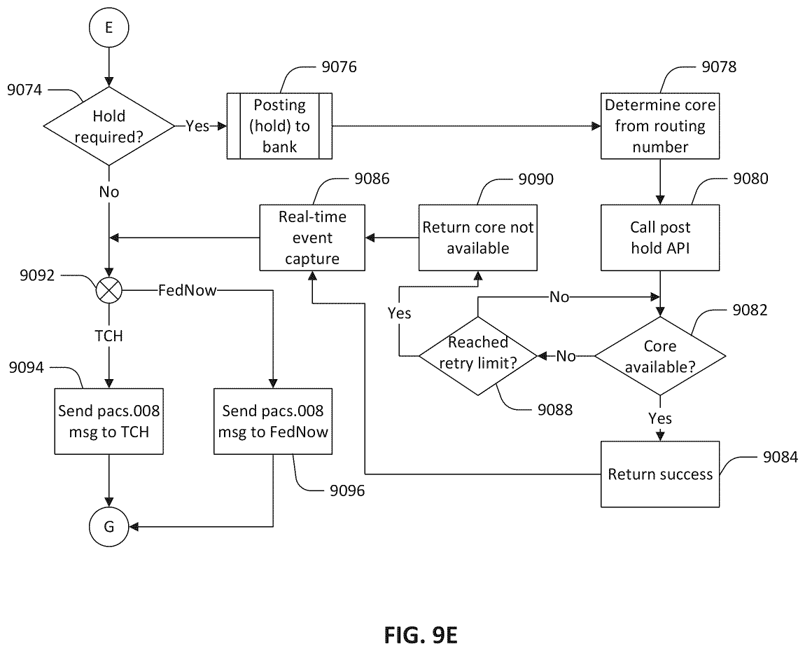

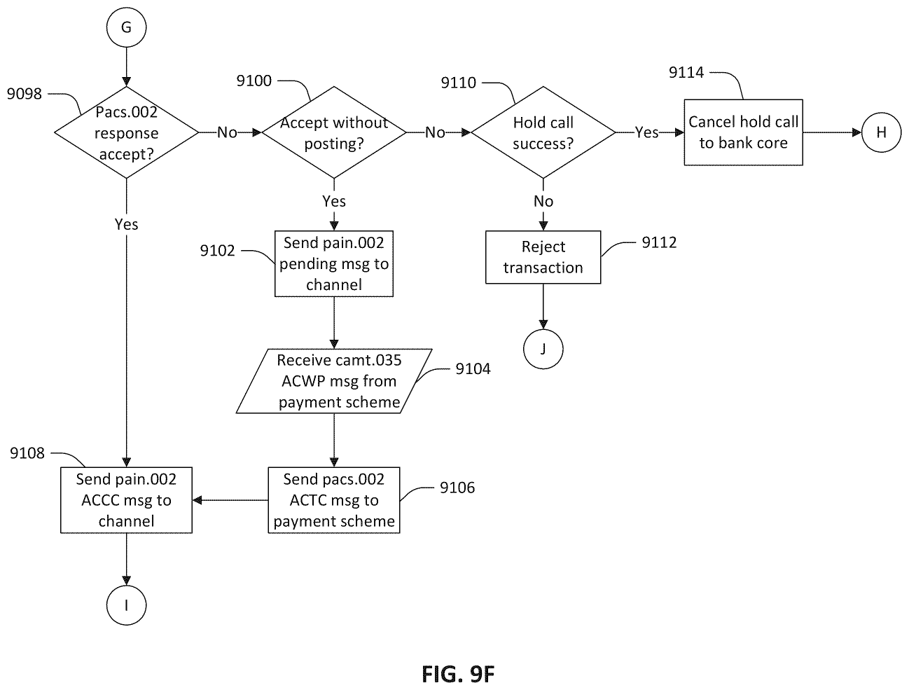

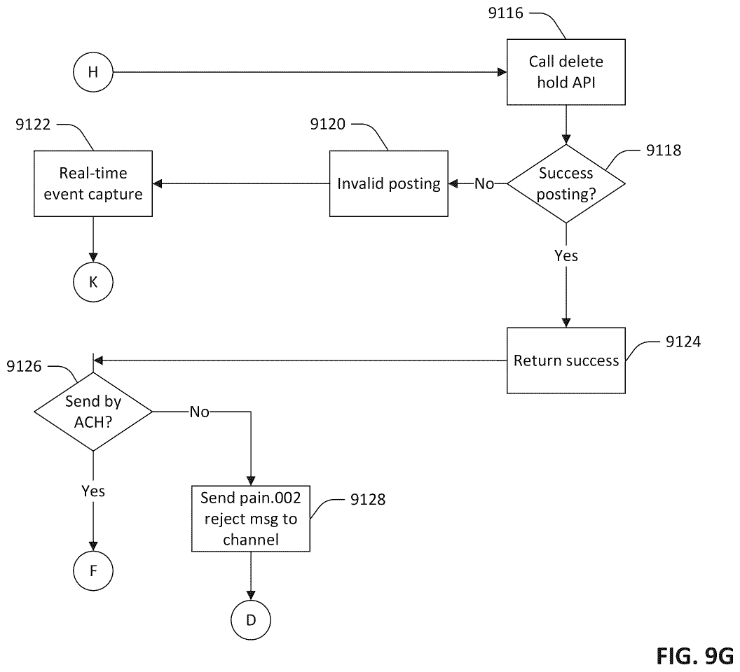

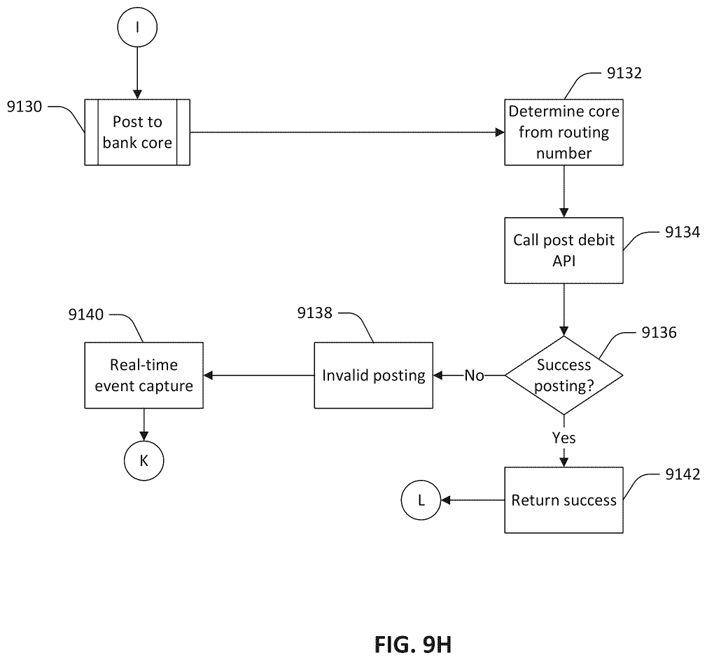

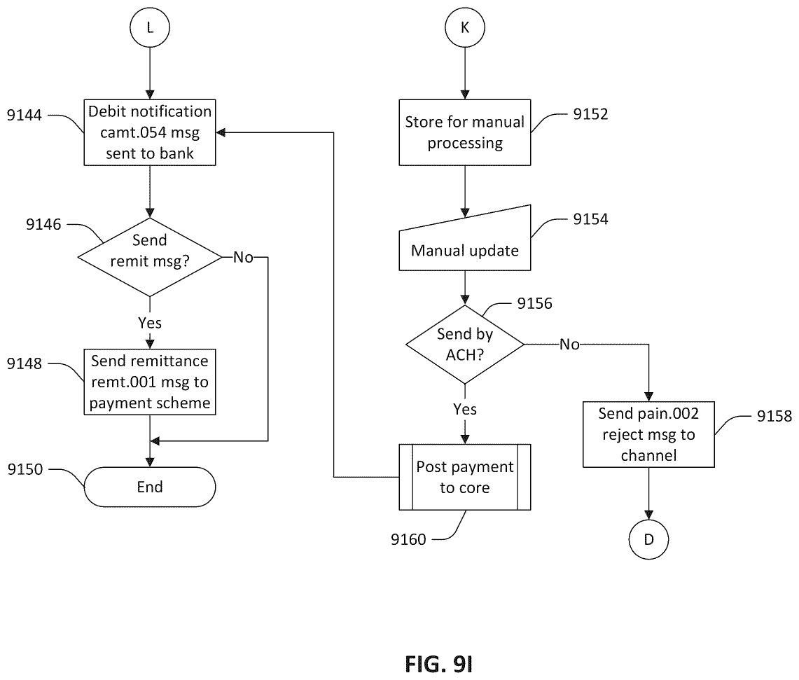

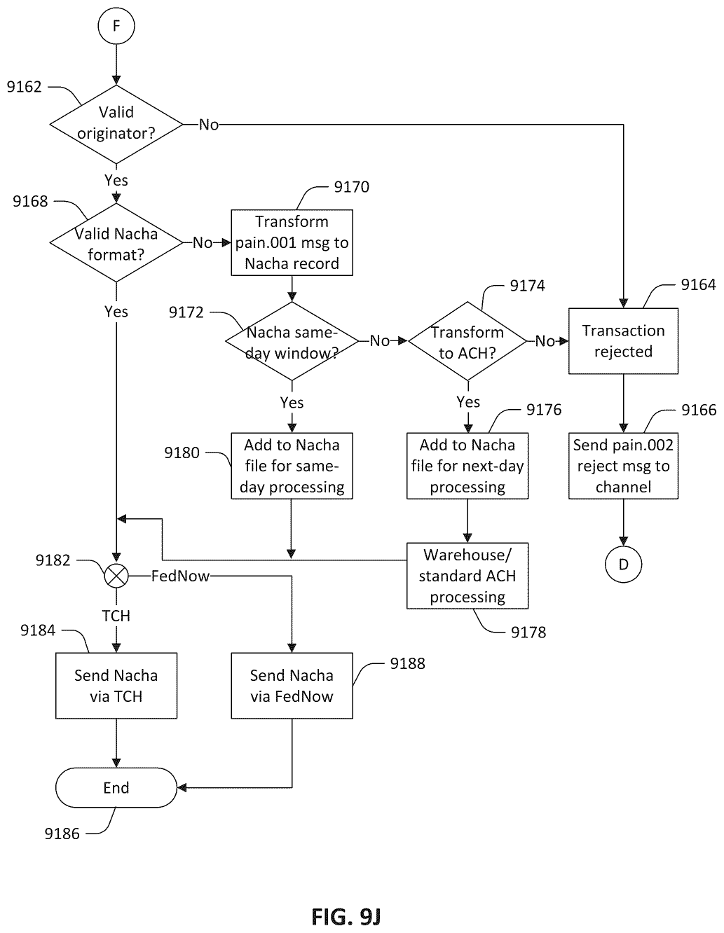

The banking platform core services integration component 2024 may be configured to provide various banking-related services in connection with money transfers, as will be described in connection with FIGS. 9A-11C. For example, the banking platform core services integration component 2024 may be configured to coordinate between the verification component 2022 and the routing and execution component 2026 to verify incoming transactions and to correctly route the transactions to their intended destinations.

The local-facing API 2030 may be configured to provide an API to enable additional features to be implemented via a common interface to the banking platform core services integration component 2024. The additional features may include one or more internal add-on components 2032. By structuring the banking platform core services integration component 2024 with the local-facing API 2030, the banking platform core services integration component 2024 may be configured to execute a minimum level of functionality to provide the banking-related services. Additional functionality may be added to the banking platform core services integration component 2024 via the internal add-on components 2032 without interrupting the basic functionality of the banking platform core services integration component 2024 or requiring the banking platform core services integration component 2024 to be taken offline to implement the additional functionality. This structure may be configured to enable a higher uptime for the banking platform core services integration component 2024, such that the MMH may continue to process transactions while features are added or updated.

The routing and execution component 2026 may be configured to perform various tasks for routing and executing transactions. The features of the routing and execution component 2026 may include payment route determination; message formatting, transmission, and receipt handling; intraday and next day management; settlement and reconciliation; protocol management; reporting and archiving; and real-time event handling. The connections 2034 may be configured to provide connections to various payment rails, including The Clearing House (TCH), the U.S. Federal Reserve's FedNow service, Automated Clearing House (ACH), wire, Society for Worldwide Interbank Financial Telecommunications (SWIFT), and other individual country-specific payment rails.

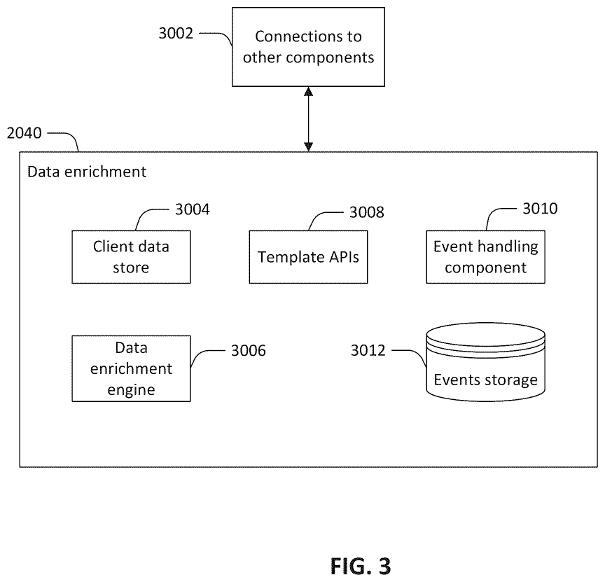

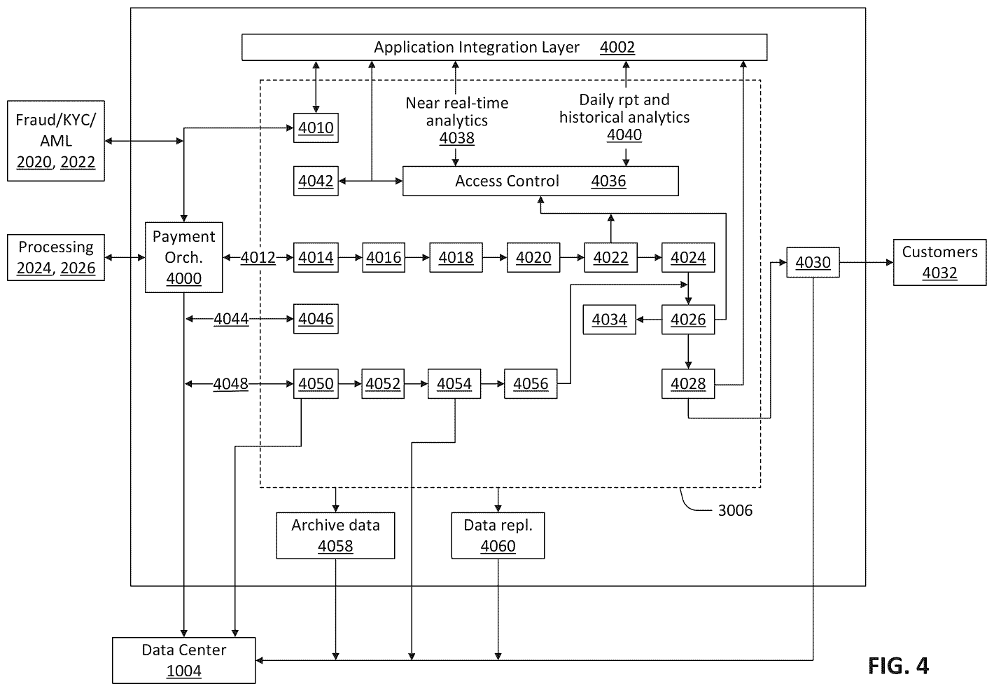

A data enrichment component 2040 may be configured to communicate with internal MMH components, such as the onboarding component 2020, the verification component 2022, the banking platform core services integration component 2024, and the routing and execution component 2026. In some embodiments, the data enrichment component may be configured to communicate with components external to the MMH, such as process orchestration and order management component 2010, via the secure gateway 2004 and the public-facing API 2002. The functionality of the data enrichment component 2040 will be discussed in greater detail in connection with FIGS. 3 and 4.

In some embodiments, the MMH may be based on a multi-tenancy model and designed to host all clients as tenants within the same platform based on a grandparent, parent, and child model. Rules and conditions for the hub may be at the grandparent level, with financial institutions at the parent level or the child level based on configuration of the hub and may be determined at the time of client onboarding. Within a given tenant, the tenant may see its own customers, e.g., all sub-tenants that are leveraging MMH services via a tenant interface, to maintain a record of sub-tenants leveraging the MMH services.

A tenant may have access to a sub-tenant's data to view data aggregation based on one or more groupings, such as number of payments sent, by rail type, by transaction date, by total amount (e.g., in aggregate, by rail type and by transaction date), and total number of failed payments (e.g., in aggregate, by rail type and by transaction date). A tenant may be able to view relationships and their corresponding data downward in the tenant relationship.

### Data Enrichment

FIG. 3 is a block diagram of the data enrichment component 2040, consistent with disclosed embodiments. The data enrichment component 2040 may be configured to provide various data processing services to MMH components 3002. For example, the MMH components 3002 may include the process orchestration and order management component 2010, the onboarding component 2020, the verification component 2022, the banking platform core services integration component 2024, and the routing and execution component 2026 shown in FIG. 2. The data enrichment component 2040 may include a client data store 3004, a data enrichment engine 3006, template APIs 3008, an event handling component 3010, and an events storage 3012.

The client data store 3004 may temporarily store data to be processed by the data enrichment engine 3006. The operation and functionality of the data enrichment engine 3006 will be described in greater detail in connection with FIG. 4. The template APIs 3008 may include various APIs that are utilized throughout the MMH, including the public-facing API 2002, connections to internal add-on components 2032, and templates used for data transformations as will be described in connection with FIG. 4. The event handling component 3010 may be configured to process various events relating to transactions during the processing of a given transaction. The events storage 3012 may be configured for temporary storage of received events before the events are processed by the data enrichment component 2040.

### Real-Time Data Delivery

FIG. 4 is a block diagram of data flows for real-time data delivery in the money management hub (MMH), consistent with disclosed embodiments. In some embodiments, the data flows shown in FIG. 4 may be performed by the MMH as shown in FIG. 2. The data flows shown in FIG. 4 are designed to capture transaction data and status information at each point of the transaction flow within the MMH. Capturing the data in this manner permits real-time or near real-time feedback of the status of each transaction as it is processed by the MMH. In some embodiments, the captured data may be stored and may be published to various entities for consumption (e.g., via a publish-subscribe model or similar data distribution model).

A payment orchestration component 4000 may be configured to communicate with fraud, KYC, and AML components (e.g., onboarding component 2020 and verification component 2022 as shown in FIG. 2), processing components (e.g., banking platform core services integration component 2024 and routing and execution component 2026 as shown in FIG. 2), data center 1004, and data enrichment engine 3006. An application integration layer 4002 may be configured to communicate with various components of the data enrichment engine 3006, as will be further described below. In some embodiments, the application integration layer 4002 may be implemented by the public-facing API 2002 as shown in FIG. 2 and may communicate with components external to the MMH (not shown in FIG. 4).

A business metadata component 4010 may be configured to communicate with the application integration layer 4002 and the payment orchestration component 4000. Data from the business metadata component 4010 may be used to improve both orchestration and integration. For example for orchestration, common data, such as common beneficiaries (e.g., utilities), may be used to ensure that the payment data is not only accurate, but enrich the transaction with the common data. The common data may also be used to verify the beneficiaries in integration, for example, verifying common beneficiaries for fraud or for common posting to bank accounts.

The payment orchestration component 4000 may be configured to send transaction enrichment data 4012 to a payment master data component 4014. The payment master data component 4014 may be configured to provide a data stream 4016 including common data, results of fraud verification, trends of payment types and numbers (which may be used to enrich payments, such as when moving to a different payment scheme) to a first data transform component 4018. The first data transform component 4018 may be configured to transform the data stream 4016 to the payment rail type and may be configured to provide the transformed data stream to a near real-time delivery component 4020. For example, the first data transform component 4018 may be configured to transform the data stream to an appropriate format to be used for the corresponding payment rail (e.g., moving from one payment rail to another payment rail) and forms the basis of smart routing as described elsewhere in this disclosure. The first data transform component 4018 may also be configured to transform data to common beneficiaries, for example, if names of supplied data does not match the beneficiary. In some embodiments where the MMH is configured to automatically repair a payment transaction or to instruct the payment schemes, the first data transform component 4018 may also be configured to correct the account type on ACH where if an invalid account type is provided, the payment transaction will post, but the account type may be modified or a message may be sent to inform the client (e.g., the bank or fintech) in real time of modifying the account type in the core.

The near real-time delivery component 4020 may be configured to provide the transformed data stream to a near real-time analytics component 4022. The near real-time analytics component 4022 may be configured to perform various near real-time analytics functions on the transformed data stream and to output the analytics to a first daily batch component 4024 and to an access control component 4036. The access control component 4036 may be configured to provide role-based security such that different users are permitted to access different data flows based on their role within the MMH. For example, in connection with the near real-time analytics, the access control component 4036 may be configured to communicate via the application integration layer 4002 to provide the near real-time analytics 4038 to users who are authorized to access the near real-time analytics 4038.

The first daily batch component 4024 may be configured to provide the near real-time analytics as a batch to a data lake 4026. The data lake 4026 may be configured to store data in various formats. In some embodiments, the data lake 4026 may include components (not shown in FIG. 4) to perform operations based on data stored in the data lake 4026. For example, the data lake 4026 may include a load and transform component to provide specific data in a structured format (as configured in the load and transform component) to a data warehouse 4028. The data warehouse 4028 may be configured to provide specified data to a report, publish, and share component 4030 which may be configured to provide various reports to customers 4032 and to the data center 1004 for storage.

The data lake 4026 may also include a component to provide data to a daily reconciliation component 4034. The daily reconciliation component 4034 may be configured to provide daily reconciliation reporting to various regulatory entities and to back office operations.

The data lake 4026 may also include a component to provide daily reports and historical analytics 4040 via the access control component 4036 and the application integration layer 4002 to users of the MMH with the appropriate permissions to view the daily reports and historical analytics 4040.

A technical metadata component 4042 may be based on transaction observability and may include technical operational data, such as conditions of service. The technical metadata may also capture trends. For example, if it is observed that a client posts 1,000 transactions every Tuesday at midday and then one day does not post any transactions, this may be an indication of an issue and an event may be raised (e.g., an alert may be sent to the client). The technical metadata may also include other items, such as the conditions of the payment rails which may provide an input into one or more of the data transform components for purposes of swapping payment rails. For example, if a real-time payment transaction on the FedNow payment rail is going to fail because the FedNow payment rail is unavailable, the routing component (as described elsewhere in this disclosure) may be configured to swap payment rails to the TCH payment rail and ensure that the payment transaction settles with TCH rather than the Fed.

The payment orchestration component 4000 may also be configured to send settlement reconciliation information 4044 to a second data transform component 4046. The second data transform component 4046 may be configured to transform the settlement reconciliation information 4044 to ensure that the payment transaction settles with the correct payment scheme/rail. For example, if the payment transaction is swapped from one payment rail to a different payment rail (e.g., between real-time payment rails such as between TCH and FedNOW) or swapping from a real-time payment rail to a non-real-time payment rail (e.g., from TCH or FedNOW to ACH), transforming the settlement reconciliation information 4044 helps to ensure that the payment transaction is settled with the payment rail that actually processed the payment transaction. The second data transform component 4046 may also be configured to provide the transformed settlement reconciliation information back to the payment orchestration component 4000.

The payment orchestration component 4000 may also be configured to send messages, events, and notifications 4048 to a raw data component 4050. The raw data component 4050 may be configured to send the messages, events, and notifications 4048 to be stored (e.g., to data center 1004). The raw data component 4050 may also be configured to send the messages, events, and notifications 4048 to a third data transform component 4052.

The third data transform component 4052 may be configured to transform the messages, events, and notifications 4048 into a standardized format and to send the transformed messages, events, and notifications 4048 to a standardized message and event storage 4054. In some embodiments, the standardized message and event storage 4054 may be configured to send the transformed messages, events, and notifications 4048 to the data center 1004 for storage. The standardized message and event storage 4054 may also be configured to send the transformed messages, events, and notifications 4048 to a second daily batch component 4056 which may forward the transformed messages, events, and notifications 4048 to the data lake 4026.

An archive data component 4058 may be configured to communicate with the data enrichment engine 3006 and receive the various data types, data streams, and processed data produced by the data enrichment engine 3006. The archive data component 4058 may be configured to phase out “active” data over time (e.g., the later in time for the data, the less “near real-time” the data becomes) and move this older data to the data center 1004 for longer-term storage.

A data replication component 4060 may be configured to communicate with the data enrichment engine 3006 and receive the various data types, data streams, and processed data produced by the data enrichment engine 3006. The data replication component 4060 may be configured to replicate the data across multiple data centers 1004, to deduplicate the data, or to otherwise optimize the data for storage.

### Payment Orchestration

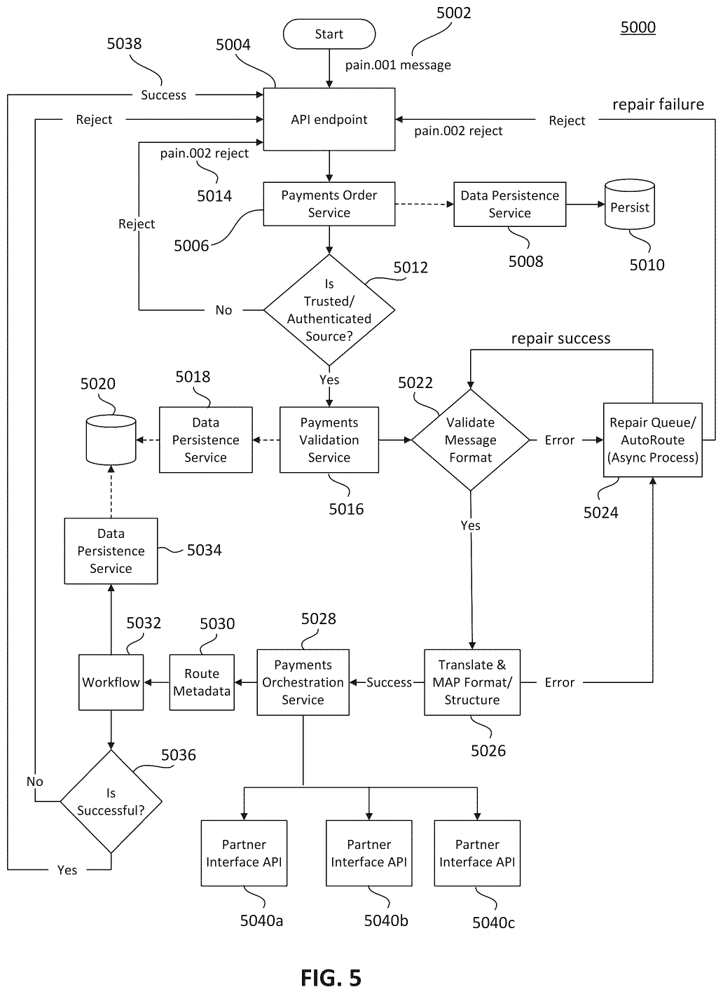

FIG. 5 is a flow diagram of a payment orchestration method 5000, consistent with disclosed embodiments. In some embodiments, the method 5000 may be performed by the MMH as shown in FIG. 2, including by components 2024 and 2026.

A customer credit transfer initiation message (e.g., a pain.001 message) 5002 is received at an API endpoint 5004. It is noted that while the examples provided in this disclosure may use standardized messages, such as ISO 20022 formatted messages, other message types may be used within the scope of the disclosure. In some embodiments, the API endpoint 5004 may be a connection between third party services and the MMH, to permit messages and transactions to pass from the third party into and out of the MMH. For example, within the MMH, ISO 20022 formatted messages may be used. In some embodiments, the MMH may use a pacs.008 payment message and a pacs.002 response message. For example, the MMH may receive a pain.001 message for credit transfers, but the API exposed to clients may be an experience API that will be transformed into a pain.001 message for processing by the MMH. The exposed experience API may provide an improved customer experience, and may be customized by the MMH host, an MMH client, or via third party services.

The initiation message 5002 is passed to a payments order service component 5006. While the payments order service component 5006 is processing the initiation message 5002, the initiation message 5002 is also sent to a data persistence service component 5008 to store the initiation message 5002 in a persistent storage 5010. In some embodiments, the persistent storage 5010 is part of the data center 1004 shown in FIG. 1. The combination of the data persistence service component 5008 and the persistent storage 5010 may be used to checkpoint the status of a message during processing, to provide granular recovery points in the event of a failure of any component of the MMH. In some embodiments, the data persistence service component 5008 may be configured to collect metrics regarding the transaction as part of transaction observability for proactive monitoring and for metering for billing purposes associated with MMH users. In some embodiments, each transaction has a single transaction identifier (ID) and throughout the transaction's life cycle, the transaction retains that single ID. The single ID may be used to track the transaction through all processing stages. For example, the data persistence service component 5008 may be configured to associate all events to the transaction through the single ID, to create an audit trail of every step of the transaction and every event associated with the transaction for later analysis.

The payments order service component 5006 examines the contents of the initiation message 5002 to determine whether the initiation message 5002 was sent by a trusted or authenticated source (step 5012). If the initiation message 5002 was not sent by a trusted or authenticated source (step 5012, “no” branch), then a rejection message 5014 (e.g., a pain.002 reject message or a customer payment status report message) is sent to the API endpoint 5004. The API endpoint 5004 communicates with the transaction initiator (e.g., the initiating customer and the customer's bank or fintech) to provide the status report or the pain.002 message.

If the initiation message 5002 was sent by a trusted or authenticated source (step 5012, “yes” branch), then the initiation message 5002 is passed to a payments validation service component 5016. While the payments validation service component 5016 is processing the initiation message 5002, the initiation message 5002 is also sent to a data persistence service component 5018 to store the initiation message 5002 in a persistent storage 5020. It is noted that data persistence service component 5018 and persistent storage 5020 perform in a similar manner as data persistence service component 5008 and persistent storage 5010 but are positioned at different parts of the flow to inform the orchestration of appropriate routes and payment interoperability. In some embodiments, the persistent storage 5020 is part of the data center 1004 shown in FIG. 1.

The payments validation service component 5016 examines the contents of the initiation message 5002 to determine whether the initiation message 5002 is in a valid message format (step 5022). If the initiation message 5002 is not in a valid message format (step 5022, “error” branch), then the initiation message 5002 is passed to a repair component 5024 to determine whether the initiation message 5002 can be repaired (e.g., whether data in the initiation message 5002 can be edited or supplemented to place the initiation message 5002 into a valid message format). The repair component 5024 may be configured to perform different types of repair, depending on the transaction status. For example, if the transaction cannot be posted due to an account communication error, the transaction may be stored for further processing and the posting may be retried when it is determined that a core is available. The transaction queue may attempt to heal itself via automated reposting based on the error codes returned. In some embodiments, the payment status may be periodically updated for that purpose (e.g., to determine whether the core is available). As another example, the client (e.g., bank, fintech, or corporation) may manually repair the transaction based on a triggering event.

For example, the triggering event may include a situation in which it has been determined that a payment can be made and the payment is attempted to be posted to the recipient's account but for some reason, the payment cannot be posted. For example, the sending account may be overdrawn and the payment cannot be completed. A logical solution would be to fail the transaction (e.g., reject the transaction because the sending account has insufficient funds to complete the transaction), but the money may have already been moved from the sending account's bank or fintech to the recipient account's bank or fintech. In such circumstances, the MMH may attempt to retry to post the transaction to the recipient's account. If the retry (or multiple retries) is unsuccessful, then the transaction may fall through to a manual queue in which human intervention may be needed to post the transaction. In some embodiments, the steps taken in attempting to post the transaction (e.g., the number of retries before a successful post or the steps taken by a human to post the transaction) may be monitored by an artificial intelligence agent to “learn” the steps taken to enable the repair component 5024 to be able to automatically repair future transactions that encounter similar situations. Once the artificial intelligence agent learns how to automatically repair transactions to enable the transactions to post, the human intervention may be removed from the repair process. In some embodiments, the artificial intelligence agent may be implemented as a neural network.

If the initiation message 5002 can be repaired by the repair component 5024, then the repaired initiation message is sent back to the payments validation service component 5016 to be re-evaluated to determine whether the repaired message is now in a valid format (step 5022). If the initiation message 5002 cannot be repaired by the repair component 5024, then a repair failure message (e.g., a pain.002 rejection message) is sent to the API endpoint 5004.

In some embodiments, the combination of step 5022 and repair component 5024 may be part of a data validation/enrichment service provided by the MMH. For example, the data validation/enrichment service may be configured to perform functions on a received message based on predefined rulesets. If the performed functions are unsuccessful, the message may be moved to the repair component 5024 (e.g., an asynchronous processing/repair queue) depending on the payment type of the message. For example, with real-time payments, the transaction may be rejected (e.g., the “repair failure” branch) and sent back to the API endpoint 5004, unless the repair component 5024 has been directed to automatically route the message to ACH or another payment type.

If the initiation message 5002 is in a valid message format or has been repaired to be in a valid message format (step 5022, “yes” branch), then the initiation message 5002 is passed to a message reformatting component 5026. In some embodiments, the message reformatting component 5026 may be configured to translate and/or map the initiation message 5002 to a different format or structure for further processing by the MMH. For example, the message reformatting component 5026 may be configured to convert various message types into an ISO 20022 format for internal use in the MMH. For example, the client configuration may indicate that a failed real-time payment message (e.g., TCH or FedNOW) should automatically create an ACH transaction to allow the payment to be processed. The internal format of transactions within the MMH is a pacs.008 message. In such circumstances, the TCH or FedNOW formatted message may be converted into a pacs.008 message. The MMH may also receive payments in Nacha format, and if necessary, the message reformatting component 5026 may also be configured to transform a Nacha formatted message into a pacs.008 message and vice versa, maintaining the complexity of the message and allowing for transformation, individual posting, or individual transaction monitoring and OFAC checks (for both outgoing and incoming payments).

If the initiation message 5002 cannot be reformatted into the different format or structure (element 5026, “error” branch), then the initiation message 5002 is passed to the repair component 5024 to determine whether the initiation message 5002 can be repaired for further processing, in a similar manner as described above. In some embodiments, the message sent to repair component 5024 may be sent with metadata or additional data (e.g., a flag or other indicator) indicating a type of repair to be performed on the message such that the repair component 5024 may be configured to perform multiple repair types on a received message.

If the initiation message 5002 can be reformatted into the different format or structure (element 5026, “success” branch), then the reformatted message is passed to a payments orchestration service component 5028. The payments orchestration service component 5028 sends the reformatted message to a metadata routing component 5030 configured to route the reformatted message to an appropriate workflow 5032 based on metadata contained in the reformatted message. For example, the workflow may be dependent on the payment type. A general overall workflow may be configured to allow for multi-payment type flows. Certain ACH actions, such as fast ACH may require a different flow than standard ACH, and these different actions may be configured as part of the general overall workflow. For example, when a particular transaction type fails, the general overall workflow may be configured to invoke another workflow (e.g., if a real-time payment fails, the MMH may, based on configuration from the client, reformat the transaction to a Nacha format for an ACH payment).

While the appropriate workflow 5032 is being performed on the reformatted message, the reformatted message is also sent to a data persistence service component 5034 to store the reformatted message in the persistent storage 5020. In some embodiments, the persistent storage 5020 is part of the data center 1004 shown in FIG. 1.

After the workflow 5032 has completed, a determination is made whether the workflow 5032 was successful (step 5036). If the workflow 5032 was not successful (step 5036, “no” branch), then the rejection message 5014 is sent to the API endpoint 5004. If the workflow 5032 was successful (step 5036, “yes” branch), then a success message 5038 (e.g., a pain.002 acceptance message) is sent to the API endpoint 5004.

The payments orchestration service component 5028 may also be configured to send the reformatted message to one or more partner interface APIs 5040a-5040c for additional processing. The partner interface APIs 5040a-5040c may be configured to provide links to external services to provide additional functionality for processing the transaction. For example, the partner interface APIs 5040a-5040c may be configured to send messages to other financial institutions, such as a customer credit transfer message (e.g., a pacs.0008 message) or a payment status report message (e.g., a pacs.0002 message). As another example, the partner interface APIs 5040a-5040c may be configured to send administrative messages, such as a real-time notification or a heartbeat message. As another example, the partner interface APIs 5040a-5040c may be configured to be used in transaction monitoring (e.g., with a pacs.008 message) to verify that the counterparty is not a fraud case or to calculate the fraud score on a transaction and adjust processing.

Payment Orchestration with Machine Learning

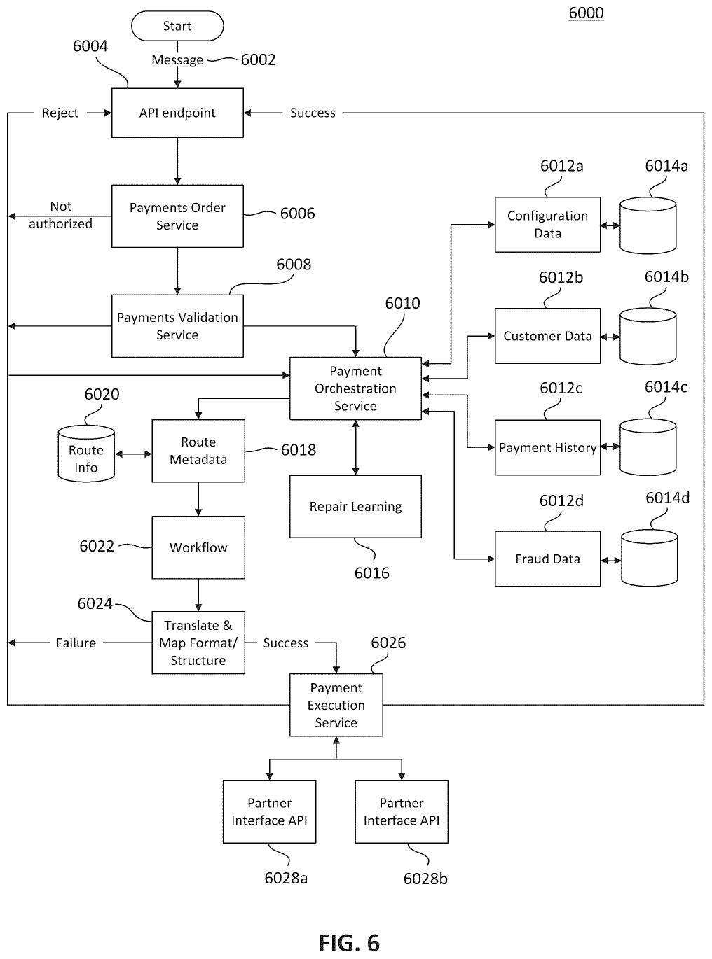

FIG. 6 is a flow diagram of a payment orchestration process 6000 using machine learning, consistent with disclosed embodiments. In some embodiments, the process 6000 may be performed by the MMH as shown in FIG. 2, including by components 2024 and 2026.

A customer credit transfer initiation message (e.g., a pain.001 message) 6002 is received at an API endpoint 6004. It is noted that while the examples provided in this disclosure may use standardized messages, such as ISO 20022 formatted messages, other message types may be used within the scope of the disclosure. In some embodiments, the API endpoint 6004 may be a connection between third party services and the MMH, to permit messages and transactions to pass from the third party into and out of the MMH.

The initiation message 6002 is passed to a payments order service component 6006. The payments order service component 6006 examines the contents of the initiation message 6002 to determine whether the initiation message 6002 was sent by a trusted or authenticated source. If the initiation message 6002 was not sent by a trusted or authenticated source (element 6006, “not authorized” branch), then a rejection message (e.g., a pain.002 reject message or a customer payment status report message) is sent to the API endpoint 6004.

If the initiation message 6002 was sent by a trusted or authenticated source (element 6006, “authorized” branch), then the initiation message 6002 is passed to a payments validation service component 6008. The payments validation service component 6008 examines the contents of the initiation message 6002 to determine whether the initiation message 6002 is in a valid message format. If the initiation message 6002 is not in a valid message format, then the initiation message 6002 is passed to a repair learning component 6016 via a payment orchestration service component 6010 to determine whether the initiation message 6002 can be repaired (e.g., whether data in the initiation message 6002 can be edited or supplemented to place the initiation message 6002 into a valid message format).

In some embodiments, the payment orchestration service component 6010 may also be configured to communicate with additional data adjustment components 6012a-6012d and corresponding data storage components 6014a-6014d. For example, the additional data adjustment components may include a configuration data adjustment component 6012a, a customer data adjustment component 6012b, a payment history data adjustment component 6012c, and a fraud data adjustment component 6012d. It is noted that additional data adjustment components 6012 may be provided without altering the operation of the process 6000. Each data adjustment component 6012 has a corresponding data storage component 6014. In some embodiments, the data storage components may be combined into a single data storage. As an example, the data adjustment components 6012a-6012d and the data storage components 6014a-6014d may be configured to store data from the payment flows and resulting from inquiries against core and customer systems. For example, the MMH may check to determine if an account exists or if the end customer is deceased. The data resulting from that determination may be recorded (e.g., in data storage components 6014a-6014d) to ensure that the payment orchestration can provide the correct information to fraud monitoring, payment status, payment rejections, the payment rails, or be used for future verification of payments to enable a more rapid response.

In some embodiments, the repair learning component 6016 includes a trained machine learning model configured to repair the initiation message 6002. For example, the machine learning model may be a neural network model and trained on patterns of transactions, for example, common beneficiaries, fraud patterns (e.g., a pattern of many transactions over a limit which are posted to the same account), or transactions which are rejected in common ways (e.g., high dollar transactions in and out). Depending on the repair type to be performed, the repair learning component 6016 may uses several different trained machine learning models, including (but not limited to), a fraud detection model (which in some embodiments may be accessed via a third-party connection to the MMH), a payment execution model (which in some embodiments may be configured to adjust transaction parameters (e.g., one or more elements of the contents of the transaction or one or more metadata elements associated with the transaction) to enable a transaction to be completed), or a routing model (which in some embodiments may be a decision type model configured based on a transaction type and used to determine, for example, a cheapest route (e.g., payment rail) for processing the transaction). A goal with the machine learning model is to update the training on a periodic (e.g., weekly) basis based on the type of transactions, beneficiaries, transaction amounts, or configuration of routable events (e.g., a real-time payment to ACH if the real-time payment fails and customer status is “VIP”).

In situations where transactions fail to complete for non-legal reasons (e.g., fail not because of fraud or a hold or stop placed on the originating account), it is desirable to determine a reason (or reasons) why the transaction failed such that future, similarly situated transactions may be completed. For example, the repair learning component 6016 may be trained to repair transactions such that the transactions may be completed. In some embodiments, the repair learning component 6016 may suggest transaction changes to the originator. For example, if the transaction contains an invalid account number, the repair learning component 6016 may be configured to send a message to the transaction originator to verify the account numbers in the transaction such that the transaction may be completed. As another example, the repair learning component 6016 may be configured to automatically correct certain aspects of a transaction, such as if the transaction originator selected a payment rail type that is not available based on other desired transaction parameters (e.g., transaction completion time or transaction cost).

If the initiation message 6002 can be repaired by the repair component 6016, then the repaired initiation message is sent back to the payments validation service component 6008 via the payment orchestration service component 6010 to be re-evaluated to determine whether the repaired message is now in a valid format. If the initiation message 6002 cannot be repaired by the repair component 6016, then a repair failure message (e.g., a pain.002 rejection message) is sent from the payments validation service component 6008 to the API endpoint 6004.

In some embodiments, the repair learning component 6016 may be part of a data validation/enrichment service provided by the MMH. For example, the data validation/enrichment service may be configured to perform functions on a received message based on predefined rulesets. If the performed function is unsuccessful, the message may be moved to the repair learning component 6016 (e.g., an asynchronous processing/repair queue) depending on the payment type of the message.

If the initiation message 6002 is in a valid message format or has been repaired to be in a valid message format, then the initiation message 6002 is passed from the payment orchestration service component 6010 to a metadata routing component 6018 configured to route the message to an appropriate workflow 6022 based on metadata contained in the message and route information 6020 from a route learning database. In some embodiments, the route information 6020 may be based on output from a trained machine learning model, such as a neural network model trained on, for example, transaction routes including available payment rails for a given payment type and timing requirements and associated costs for each payment rail type. For example, the metadata routing component 6018 may be configured to use a trained machine learning model and may use the metadata in the initiation message 6002 and information on how similar messages were routed to determine a “best route” for completing the transaction. For example, the “best route” may be a route that completes the transaction in the shortest amount of time, for the lowest cost, along a caller-preferred payment rail, or a weighted combination of these factors.

In some embodiments, the machine learning model may be based on a rules configuration engine and may be configured to determine the route based on the type of originating caller (e.g., a bank, a fintech, or a corporation). For example, the caller may define rules to transition from a real-time payment transaction to a same day ACH transaction or a next day ACH transaction. The rules may be applied in a situation where the transaction is unable to be completed over a real-time payment rail, but the caller wants to complete the transaction in a same day process or a next day process. As another example, the API call to the MMH may include an override field to enable the transaction in the API call to be pushed to a specific route (e.g., a specific payment rail, such as real-time payment, ACH, wire transfer, international SWIFT transaction, or an international wire transfer).

In some embodiments, the machine learning model may be trained based on enriched or enhanced prior transaction data, such as customer data, client configuration data, payment history, and fraud data to learn the “best route.” For example, the transaction data may include client segment, client type (e.g., an individual consumer or a business), risk scoring (e.g., credit scores), previous payment routes, previous transaction types, previous destinations, previous transaction origination sources, and payee confirmation.

After the workflow 6022 has completed, the processed message is passed to a message reformatting component 6024. In some embodiments, the message reformatting component 6024 may be configured to translate and/or map the processed message to a different format or structure for further processing by the MMH. In some embodiments, the message reformatting component 6024 may be configured to reformat the message based on the selected route from the metadata routing component 6018. For example, if the metadata routing component 6018 determines that the best route for the transaction is over the ACH payment rail, then the message reformatting component 6024 may be configured to reformat the transaction into a Nacha file for transmission over the ACH payment rail. If the processed message cannot be reformatted into the different format or structure (element 6024, “failure” branch), then a rejection message is sent to the API endpoint 6004.

If the processed message can be reformatted into the different format or structure (element 6024, “success” branch), then the reformatted message is passed to a payment execution service component 6026. The payment execution service component 6026 may be configured send the reformatted message to one or more partner interface APIs 6028a, 6028b for additional processing. The payment execution service component 6026 may also be configured execute the payment transaction indicated by the message. If the payment transaction is successfully executed (element 6026, “success” branch), then a success message may be sent to the API endpoint 6004. If the payment transaction is not successfully executed (element 6026, “reject” branch), then a rejection message may be sent to the API endpoint 6004.

### Transaction Monitoring

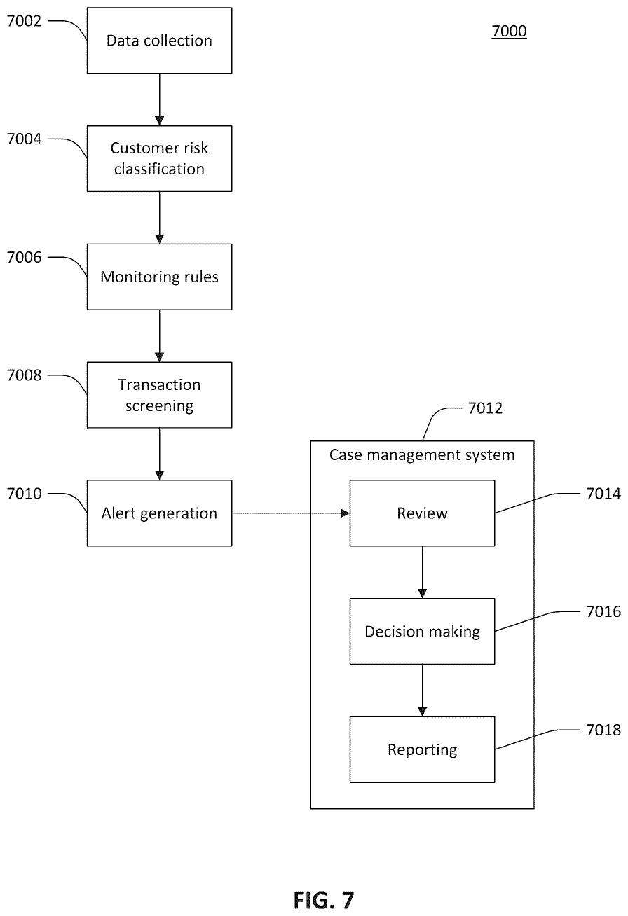

FIG. 7 is a flow diagram of a transaction monitoring process 7000, consistent with disclosed embodiments. In some embodiments, the transaction monitoring process 7000 may be performed by a fraud monitoring component in the MMH. In some embodiments, the transaction monitoring process 7000 may be provided by a third party and may be implemented as an internal add-on component to the MMH (e.g., internal add-on component 2032 as shown in FIG. 2).

The transaction monitoring process 7000 may be used for fraud detection in the MMH. In some embodiments, the transaction monitoring process 7000 may include fraud detection on blockchain and other distributed ledger technology types, providing a predictive fraud detection model based on user device and user behavior, check against global sanctions lists, account takeover prevention, social engineering fraud detection, and similar fraud monitoring and detection functionality. In some embodiments, the transaction monitoring process 7000 may include machine learning capabilities for non-standard rule based decision making.

In some embodiments, the transaction monitoring process 7000 may be performed during processing a single transaction, to attempt to identify a potentially fraudulent transaction before it progresses “too far” in the processing pipeline. For example, the fraud check may happen once in a send transaction and once in a receive transaction. In a send transaction, the fraud check may happen prior to issuing the payment request to the payment scheme (or payment rail) and checks the counterparty of the sending party. In a receive transaction, the fraud check may happen on the incoming message prior to an account check to ensure that the payment is rejected if the sender is fraudulent. For example, the transaction monitoring process 7000 may be performed prior to making a payment (e.g., before money is transferred to the intended recipient), prior to marking a payment as “ready to send,” or during customer onboarding (e.g., by performing “know your customer” (KYC) or “know your business” (KYB) checks).

Some examples of checks that may be made to determine whether the transaction includes an indication of potential fraud include a transaction amount, a velocity check (e.g., a number of transactions in a predetermined period of time, such as one week), whether the transaction involves a new vendor, or a check against historical data (e.g., a review of historical data over a rolling six month period). It is noted that other types of checks may be made and are contemplated to be within the scope of operation of the transaction monitoring process 7000.

A data collection component 7002 may be configured to collect data from various sources, including, but not limited to bank systems, card networks, and third parties. The various data sources provide inputs to the transaction monitoring process 7000.

A customer risk classification component 7004 may be configured to calculate a risk score for the transaction. If the fraud component detects that a transaction is a risk, the MMH may allow the payment to post and the customer risk classification component 7004 calculates a risk score for the transaction. For example, if the risk score is determined to be a “medium” level, the customer risk classification component 7004 may trigger an event to the client (e.g., bank, fintech, or corporation). For example, a payment transaction may be allowed to post even if a medium fraud risk is determined for the payment transaction. In such a case, a status of “research required” may be created. This status notifies the client they need to research this payment transaction, look at the trends, and possibly adjust risk scoring and fraud models to verify these types of scenarios. These adjustments may improve the fraud models, may reduce risks of false positives, and may allow for adjustment of orchestration to determine decision of posting or payment acceptance. In some embodiments, the risk score levels may be configurable and the risk score may be based on customer data (e.g., location/IP address), transaction amount, transaction status, etc.

A monitoring rules component 7006 may be configured to include rules that may be evaluated against the collected data to provide one or more indicators of a potentially fraudulent transaction. In some embodiments, the monitoring rules component 7006 may be configured to permit a user of the MMH (subject to proper security checks) to build or otherwise define rules that may be processed by the monitoring rules component 7006.

A transaction screening component 7008 may be configured to apply the monitoring rules to analyze a given transaction to determine whether the transaction exhibits one or more indicators of a potentially fraudulent transaction. In some embodiments, the transaction screening component 7008 may be configured to apply the rules to all transactions. In some embodiments, the transaction screening component 7008 may include a machine learning component trained to determine whether the transaction exhibits one or more indicators of a potentially fraudulent transaction. For example, the trained machine learning component may be a neural network model trained for fraud detection and in some embodiments may be provided via a third party connection.

An alert generation component 7010 may be configured to generate an alert when a transaction matches a predefined rule in the transaction screening component 7008 or the machine learning component of the transaction screening component 7008 detects a potentially fraudulent transaction. In some embodiments, the alert generation means that the transaction is passed to a case management system 7012 for further processing. In some embodiments, the alert generation component 7010 may be configured to communicate with the data enrichment component 2040 to add an indicator to the data associated with the transaction that the transaction has been marked as potentially fraudulent. For example, the transaction may have a “payment completed” status, but further research may be required to show that a risk score came back as a medium level risk and the transaction needs to be further investigated.

In some embodiments, the case management system 7012 may be a separate system or process (e.g., performed by a different entity than the transaction monitoring process 7000) for handling potentially fraudulent transactions. The case management system 7012 may be configured to organize different alerts into cases, and each case may contain multiple alerts. For example, a single transaction may generate a number of alerts if it contains multiple indicators of being a potentially fraudulent transaction.

Once created, a case is passed to a review component 7014. In some embodiments, the review component 7014 may be configured to assign a case to a human to review the case to determine whether the identified transaction is a “false positive” or not. In other embodiments, the review component 7014 may be configured to assign a case to an automated component (e.g., a trained machine learning model) to review the case to determine whether the identified transaction is a “false positive” or not.

A decision making component 7016 may be configured to receive the results of the human's investigation or the results of the machine learning model's investigation from component 7014. For example, if the transaction is a “false positive,” then the potentially fraudulent indicator may be cleared from the transaction, the transaction data updated to reflect the clear flag, and the transaction returned from the transaction monitoring process 7000 to the MMH for additional processing. As another example, if the result of the review (from the review component 7014) indicates that the transaction is a fraudulent transaction or may be a fraudulent transaction (e.g., indicates with a predetermined degree of confidence that the transaction is a fraudulent transaction), the case may be escalated for further processing or may be rejected. In some embodiments, the decision making component 7016 may be configured to communicate with a “know your customer” (KYC) component to provide additional data and/or verification for the transaction. In some embodiments, the decision making component 7016 may be configured to communicate with the data enrichment component 2040 to add data to an audit trail for the transaction.

A reporting component 7018 may be configured to receive results from the decision making component 7016 and automatically generate a report to be filed with the appropriate government authorities if the transaction or the case meets the threshold for reporting. For example, a Suspicious Activity Report may need to be filed depending on the particular transaction.

In some embodiments, the transaction monitoring process 7000 may be configured to evaluate various key performance indicators (KPIs) to evaluate transactions for potential fraud. The KPIs may include: approval versus denial rate, wherein an approval refers to a volume of transactions that receive an “approved” status after screening; incoming pressure or fraud rate, which is the total volume of transactions identified as fraudulent, regardless of whether those transactions were approved or rejected; an automatic acceptance rate; an automatic rejection rate; a manual review rate; a precision versus false positives metric (e.g., a false positive rate); or a fraud-to-sales ratio.

### Transaction Routing Overview

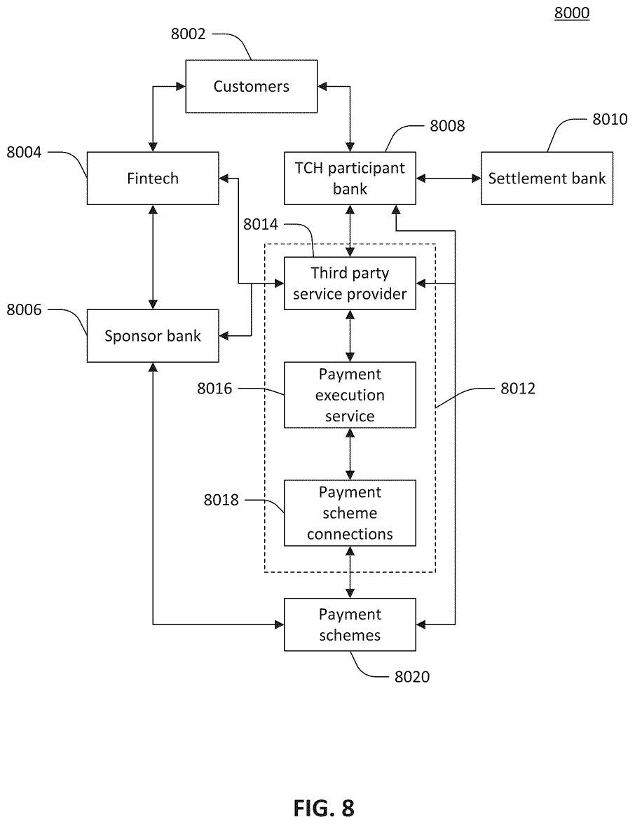

FIG. 8 is a flow diagram of a transaction routing process 8000 between different entities, consistent with disclosed embodiments. It is noted that the entities shown in FIG. 8 may be connected by electronic communications means (e.g., an Internet or other network connection) and may also be connected by commercial agreements.

In some embodiments, customers 8002 may have an account with a fintech 8004. To provide access to financial services, the fintech 8004 may communicate with a sponsor bank 8006 to provide the necessary services and legal permissions to provide financial services to the customers 8002.

In other embodiments, customers 8002 may have an account with a TCH (The Clearing House) participant bank 8008. The participant bank 8008 may work with a settlement bank 8010 to settle transactions made by the customers 8002.

The fintech 8004, the sponsor bank 8006, and the participant bank 8008 may communicate with the MMH 8012. The MMH 8012 may include a third party service provider 8014 that communicates with a payment execution service 8016, which in turn communicates via payment scheme connections 8018 with various payment schemes 8020. The sponsor bank 8006 and the TCH participant bank 8008 may indirectly communicate via one or more payment schemes 8020. As described elsewhere in this disclosure, the MMH 8012 may be configured to provide additional functionality than that shown in FIG. 8.

In some embodiments, the payment execution service 8016 may include a payment routing engine and a payment engine (not shown in FIG. 8). The payment routing engine may be configured to provide: access to different payment schemes (e.g., different payment rails), an expected date of settlement for the payment based on data contained in the payment initiation message and based on the payment rail over which the payment will be processed, payment scheme availability information (e.g., payment scheme operation times, holidays, and planned maintenance schedules), individual payment value limits per payment scheme, a cost for processing the payment on a payment scheme, and adjustments to the payment processing routing (e.g., to a particular payment scheme or payment rail) based on the sender's preferences (e.g., least cost for processing the payment, fastest time to process the payment, etc.).

The payment engine may be configured to: act as an orchestration layer between scheme specific adapters (e.g., interface with payment scheme connections 8018); handle all payment scheme agnostic actions (e.g., validation, outbound integration into other MMH systems, auditing, etc.); and respond to incoming payment messages, including interacting with other core MMH systems to decide whether the incoming payment can be accepted and update balances on the related accounts.

In some embodiments, the payment scheme connections 8018 may include multiple components or interfaces to enable the MMH to connect to different payment schemes. For example, each payment scheme connection may be specific to a particular payment scheme, such as TCH or FedNow. A payment scheme connection 8018 may be configured to: translate outbound messages into a format used by the payment scheme, for example, ISO 20022 formatted messages; send messages via a process or format required by the payment scheme, such as via IBM MQ; receive inbound payment messages and pass the messages to the payment engine; send or receive administrative or non-payment messages required by the payment scheme; and support messages required for sending and responding to “request to pay” messages received from the network.

The payment execution service 8016 may also communicate with a report engine (not shown in FIG. 8). The report engine may be configured to generate reports required for settlement reconciliation and generate regulatory reports for payment scheme-specific regulatory reporting requirements.

The payment execution service 8016 may also communicate with an event submitter (not shown in FIG. 8). The event submitter may be configured to communicate with data storage (e.g., a data lake or other type of data storage), to reflect internal state changes in inbound payments and outbound payments; to submit or publish transactions to the data storage; and to generate insights or provide troubleshooting use cases.

The payment execution service 8016 may also communicate with additional support functionality (not shown in FIG. 8). The additional support functionality may provide real-time querying of individual payments or groups of payments and support for reprocessing of previously rejected payments. For example, if a payment is “held” (with a status) due to a failure to post the transaction to a core, the transaction may be able to be reprocessed via the back office component (e.g., via back office UI 2016 shown in FIG. 2).

### Processing an Incoming Send Transaction

FIGS. 9A-9J are a flowchart of a method 9000 for processing an incoming send transaction, consistent with disclosed embodiments.

The method 9000 may be entered from different points, depending on whether the initiating institution is a non-hub member or a hub member. The difference between a non-hub member and a hub member is that a hub member will already be authenticated into the MMH when a customer of the hub member accesses their account through the hub member. In such circumstances, the customer of the hub member already has their credentials verified by the hub member, permitting access to the MMH without further authentication. For a customer of a non-hub member, that customer will need to have their credentials verified prior to being granted permission to access the MMH.

A call from a non-hub member bank or fintech may be created (step 9002). To create the call, a customer of the non-hub member bank or fintech may access their account with the non-hub member bank or fintech and initiate a money transfer request. The customer's credentials (e.g., security and authentication-related information to verify the customer) are passed from the non-hub member bank or fintech to a MMH processing universal API to verify the customer's credentials (step 9004). In some embodiments, the MMH processing universal API may be implemented as the verification component 2022 shown in FIG. 2. In some embodiments, the MMH processing universal API may be an API accessed by non-hub member banks and fintechs as an initial entry point to the MMH.

A call from a hub member bank or fintech may be created (step 9006). To create the call, a customer of the hub member bank or fintech may access their account with the hub member bank or fintech and initiate a money transfer request. Because the customer of the hub member bank or fintech has already had their credentials verified by accessing their account with the hub member bank or fintech, their credentials have already been verified (step 9008).

In some embodiments, a non-hub member and a hub member may use different API calls to access the MMH. For example, a non-hub member API call may not include a secure key to permit MMH access because the non-hub member has not already been authenticated to access the MMH. As another example, the hub member API call may include the secure key because the hub member has already been authenticated to access the MMH. In some embodiments, both API calls may be received at a single entry point and may be evaluated to determine whether the API call includes the secure key. If the secure key is missing from the API call, then that API call needs further authentication prior to accessing the MMH. In some embodiments, the API calls may be received by an identity manager that determines whether the secure key is present in the API call. For example, the identity manager may utilize an OAuth 2.0 protocol, a SAML 2.0 protocol, or other security verification protocol.

After verifying a customer's credentials (either via step 9004 or step 9008), a token to access the MMH (MMH access token) is generated (step 9010). In some embodiments, the MMH access token may be generated based in part on the secure key included in the transaction request/API call. A separate MMH internal token may be generated and include account-related information, as will be further described below. It is noted that the MMH access token and the MMH internal token are two separate tokens and have separate uses. For example, the MMH access token may be used to grant access for the account to the MMH and the MMH internal token includes account-related information that may be access by various MMH components once the account has been granted access to the MMH.

In some embodiments, when a customer signs on to their account (whether through a hub member or non-hub member bank or fintech), the MMH access token may be generated as part of the customer's sign-on process. In such circumstances, the authentication process performed during the customer sign-on process may be used to authenticate the customer to access the MMH. For example, the hub member or non-hub member bank or fintech will have previously requested access to the MMH API for their customers and as part of this process, the bank or fintech may be approved to provide MMH access tokens to their customers after the customers are authenticated by the bank or fintech. For example, secure rotating tokens may be used, such as in connection with a secure token protocol (e.g., an OAuth 2.0 access token to access the MMH API).

After the MMH access token is generated, a determination is made whether a banking core is available (step 9012). Based on the incoming transaction request, the transaction may be processed by different banking cores. For example, factors that may be considered in determining the banking core to handle the transaction may include the transaction source (e.g., the bank or fintech where the initiating customer has an account) or the destination source (e.g., the bank or fintech that will receive the funds associated with the transaction). As another example, this determination may include determining whether the account indicated in the transaction exists, is open, and allows posting. If all three of these conditions are not true, then the transaction may be rejected at this point without further processing, thereby saving time and processing resources.

For example, a banking core may not be accessible because the banking core is offline, the banking core has reached a transaction capacity limit, or there was a network connection issue while attempting to access the banking core. If the banking core is not available (step 9012, “no” branch), a determination is made whether a retry limit has been reached (step 9014). For example, the retry limit may be based on a predetermined period of time (e.g., five seconds) during which the banking core may be attempted to be accessed numerous times within the predetermined period of time. As another example, the retry limit may be based on a number of attempted accesses (e.g., ten accesses). If the retry limit has not been reached (step 9014, “no” branch), then the method 9000 returns to step 9012 to determine whether the banking core is available.

If the retry limit has been reached (step 9014, “yes” branch), then an update that the banking core was not available is sent to the caller (e.g., the initiating bank or fintech; step 9016) and the method 9000 terminates.

If the banking core is available (step 9012, “yes” branch), a determination is made whether the transaction is an ACH transaction (step 9018). If the transaction is not an ACH transaction (step 9018, “no” branch), then a determination is made whether the banking core can post transactions to the account (step 9020). As used herein, the term “post transactions” means that it is possible to make a payment from the account. For example, there may be a stop or a hold on the account, which would prevent payments from being made from the account. If it is unclear whether the banking core can post transactions to the account (e.g., if the transaction originated from a non-hub member, the MMH internal token may not include the necessary account information to determine whether there are any posting restrictions on the account; step 9020, “unclear” branch), then a restrictions inquiry is called to determine whether there are any restrictions imposed on the originating account (step 9022). For example, restrictions may be placed on an account if there has been fraud on the account or if a hold or stop has been placed on the account. The restrictions inquiry may be sent to the originating bank or fintech to determine whether there are any restrictions on the account. The method 9000 then returns to step 9020 to obtain a yes or no determination (which would be returned from the restrictions inquiry call) whether the banking core can post transactions to the account. In some embodiments, it may be preferable to determine as early as possible in processing a transaction whether the transaction can be completed. For example, if there are restrictions on the account and the payment cannot be made from the account, making the determination that the transaction cannot be completed early in the process saves processing resources and time.

If there are restrictions on the account, then transactions cannot be posted to the account. If transactions cannot be posted to the account (step 9020, “no” branch), then an update is sent to the caller (e.g., the initiating bank or fintech) that transactions cannot be posted to the account (step 9024) and the method 9000 terminates. In some embodiments, a hub member bank or fintech may receive additional status-related information in the update. For example, there may be more granularity in terms of the number of messages provided or the level of detail provided in the messages to the hub member bank or fintech.

If transactions can be posted to the account (step 9020, “yes” branch), the transaction is considered to be a “trusted transaction” and a determination is made whether the transaction includes an indication whether the transaction is a standard payment request (step 9026). For example, if the indication does not indicate an override, then the transaction is a standard payment request. If the transaction is not a standard payment request (step 9026, “no” branch), then the transaction includes an indication that it is to be processed on a specific payment scheme, overriding typical payment processing for that type of transaction (step 9028).

If the transaction is an ACH transaction (step 9018, “yes” branch), then an ACH file is created for further transaction processing (step 9030).

At selector 9032, a determination is made whether the transaction is in an ACH file (from step 9030) or is an API message (from steps 9026 or 9028). In some embodiments, if transaction is from a customer of a hub member bank or fintech, the authentication and verification steps described in FIGS. 9A and 9B may be bypassed and the transaction may enter the method 9000 at selector 9032. During the customer sign-on process, a customer of a hub member bank or fintech may complete the same or similar authentication and verification steps described in FIGS. 9A and 9B and as such, would not need to repeat those steps before transaction processing can begin.

If the transaction is an ACH file, it is received in a Nacha file format (step 9034). The Nacha file is prepared to be sent over the ACH payment rail for further processing (step 9036). The further processing for the Nacha file will be described at connector F in connection with FIG. 9J.

If the transaction is an API message, then it may be received as an ISO 20022 message (which is a financial industry standardized messaging scheme), such as a pain.001 message (step 9038). The pain.001 message is a customer credit transfer initiation message and is sent to the debtor, to request funds to be moved from the debtor's account to the creditor's account.

A determination is made whether the pain.001 message has a valid message structure (step 9040). This is the first of several checks to examine the pain.001 message to ensure that it complies with the standard, contains correct information (e.g., no missing or transposed digits in an account number) and does not include any possibly fraudulent elements. If the pain.001 message structure is not valid (step 9040, “no” branch), then the message interchange is rejected (step 9042). An admi.002 rejection message is sent back to the transaction originator (step 9044). The admi.002 rejection message is an administrative-type message that is sent to a caller when the preceding message is rejected and may include a reason for the rejection.

The rejection message is sent for real-time event capture (step 9046 in FIG. 9D). An event update is sent to the caller (e.g., the initiating bank or fintech; step 9048) and the method 9000 terminates. In some embodiments, the event update sent to the caller may be based on the contents of the admi.002 rejection message. In some embodiments, each transaction has a single transaction identifier (ID) and throughout the transaction's life cycle, the transaction retains that single ID. In some embodiments, the single ID may be included in the MMH internal token and may be assigned when the MMH internal token is created. The single ID may be used to track the transaction through all processing stages. For example, the real-time event capture (step 9046) may be used to associate all events to the transaction through the single ID, to create an audit trail of every step of the transaction and every event associated with the transaction for later analysis.

Referring back to FIG. 9C, if the pain.001 message structure is valid (step 9040, “yes” branch), then a determination is made whether the pain.001 message is a duplicate message (step 9050). If the pain.001 message is a duplicate message (step 9050, “yes” branch), then the message interchange is rejected (step 9042) and the method 9000 continues with step 9044 as described above.

If the pain.001 message is not a duplicate message (step 9050, “no” branch), then a determination is made whether the interchange data in the pain.001 message is valid (step 9052). For example, the interchange data may include the data that the payment rail (payment scheme) needs to be able to complete the transaction, such as bank data with a valid routing code (e.g., the correct number of digits). If the interchange data is not valid (step 9052, “no” branch), then the message interchange is rejected (step 9054). A pain.002 rejection message is sent back to the caller (e.g., the initiating bank or fintech; step 9056) and the method 9000 continues with step 9046 as described above. The pain.002 message is a customer payment status report message and is sent to the previous party in the message chain regarding the current instruction status.

If the interchange data in the pain.001 message is valid (step 9052, “yes” branch), then a determination is made whether the instruction data in the pain.001 message is valid (step 9058). For example, the instruction data may include one of several different instruction types permitted in the pain.001 message format. If the instruction data in the pain.001 message is not valid (step 9058, “no” branch), then the instruction is rejected (step 9060). A pain.002 rejection message is sent back to the caller (e.g., the initiating bank or fintech; step 9062) and the method 9000 continues with step 9046 as described above.

If the instruction data in the pain.001 message is valid (step 9058, “yes” branch), then a determination is made whether the fraud configuration in the pain.001 message indicates a trusted transaction (step 9064). If the fraud configuration does not indicate a trusted transaction (step 9064, “no” branch), then a fraud check process is performed (step 9066). For example, the fraud check process may verify the transaction against transaction limits, the sender/receiver (e.g., name, address, Social Security Number) is verified against external data (e.g., bureaus, lists), and may include both a transaction monitoring (e.g., AML) and OFAC verification.

After the fraud check process completes, a fraud response status is returned and a determination is made whether the fraud response status indicates that fraud check process passed (step 9068). If the fraud check did not pass (e.g., indicating that the transaction may be fraudulent; step 9068, “no” branch), then a pain.002 rejection message is sent back to the caller (e.g., the initiating bank or fintech; step 9062) and the method 9000 continues with step 9046 as described above.

If the fraud configuration in the pain.001 message indicates a trusted transaction (step 9064, “yes” branch) or if the fraud check passes (step 9068, “yes” branch), then a determination is made whether the participant validation is successful (step 9070). For example, in a send transaction, this check may determine whether the counterparty (e.g., the creditor) indicated in the pain.001 message is a valid party. As another example, in a receive transaction, this check may determine whether the counterparty (e.g., the debtor) indicated in the pain.001 message is a valid party. If the participant validation fails (step 9070, “no” branch), then the instruction is rejected (step 9072). A pain.002 rejection message is sent back to the caller (e.g., the initiating bank or fintech; step 9062) and the method 9000 continues with step 9046 as described above.

If the participant validation succeeds (step 9070, “yes” branch), then a determination is made whether a hold on the account is required (step 9074). If a hold on the account is required (step 9074, “yes” branch), then a hold is posted to the bank core currently processing the transaction (step 9076). The bank core currently processing the transaction is determined from a routing number for the account in the transaction (step 9078) and a call is made to a post hold API (step 9080). The post hold API enables the bank core to place a hold on account transactions for the account specified in the transaction.

After the post hold API is called (step 9080), a determination is made whether the bank core currently processing the transaction is available (step 9082). At this point in the processing, the determination whether the bank core is available may include a determination whether the funds can be posted to the account. For example, there may be a network or other type of communication error that prevents the funds from being posted to the account. In such circumstances, the transaction may be held in a repair queue for repair processing, as described elsewhere in this disclosure. If the bank core is available (step 9082, “yes” branch), then a success status is returned (step 9084) and the status is sent for real-time event capture (step 9086).

If the bank core is not available (step 9082, “no” branch), then a determination is made whether a retry limit has been reached (step 9088). The retry limit used in step 9088 may be similar to the retry limit described elsewhere in this disclosure and may be based on a predetermined period of time (e.g., five seconds) or on a number of attempted accesses (e.g., ten accesses). If the retry limit has not been reached (step 9088, “no” branch), then the method 9000 returns to step 9082 to determine whether the banking core is available. If the retry limit has been reached (step 9088, “yes” branch), then a status message is returned that the bank core is not available (step 9090) and the status is sent for real-time event capture (step 9086). In some embodiments, whether the transaction is rejected at this point depends in part on the processing. For example, if this status exists at the first check point (e.g., validation that the account exists, is open, and allows posting of transactions to the account), then the MMH is likely to reject the transaction or look at the bank configuration to determine whether the MMH stands in for the core and posts the transaction to the payment scheme/rail. This determination depends on the risk scoring of the banks. For example, 99% of banks may want to reject the transaction rather than stand in for the core, allow the transaction to post, and then reconcile in an asynchronous method. The flexibility provided by the MMH enables a configuration for this option.

If a hold on the account is not required (step 9074, “no” branch) or after the real-time event capture is completed (step 9086), flow proceeds to a selector 9092 to determine routing configuration for the transaction. For example, the transaction may be routed via the TCH payment rail or the FedNow payment rail. If the transaction is to be routed via the TCH payment rail, then a pacs.008 message is sent to the TCH payment rail (step 9094). A pacs.008 message is a financial institution to financial institution customer credit transfer message sent by the debtor to the creditor and is a request to move funds from the debtor's account to the creditor's account. If the transaction is to be routed via the FedNow payment rail, then a pacs.008 message is sent to the FedNow payment rail (step 9096).

After the pacs.008 message is sent (steps 9094 or 9096), a determination is made whether a pacs.002 response accept message was received by the MMH (step 9098). For example, the pacs.002 message may include an “ACTC” code to indicate that the transaction has been accepted by the recipient. If a pacs.002 response accept message was not received (step 9098, “no” branch), then a determination is made whether the transaction was accepted without posting (step 9100). For example, the pacs.002 message may include an “ACWP” code to indicate that the transaction has been accepted but cannot be posted to the recipient's account. There may be numerous reasons why a transaction could not be posted to the recipient's account, but this does not prevent the transaction from being received by the recipient's bank or fintech.

If the transaction was accepted without posting (step 9100, “yes” branch), then a pain.002 pending message is sent to the channel (e.g., the initiating bank or fintech; step 9102). For example, in step 9102, the current instruction status is that the transaction is pending. A camt.035 accept without posting (ACWP) message is received from the payment scheme (step 9104). The camt.035 message is a payment acknowledgement message used by a receiver to confirm receipt of funds. A pacs.002 accept (ACTC) message is sent to the payment scheme to acknowledge the camt.035 message (step 9106).

If a pacs.002 response accept message was received (step 9098, “yes” branch) or after the pacs.002 ACTC message is sent (step 9106), a pain.002 accepted settlement completed (ACCC) message is sent to the channel (e.g., the initiating bank or fintech; step 9108).

If the transaction was not accepted without posting (step 9100, “no” branch), then a determination is made whether the hold call on the account was successful (step 9110). If the hold call on the account was not successful (step 9110, “no” branch), then the transaction is rejected (step 9112) and a pain.002 rejection message is sent (step 9062) as described in connection with FIG. 9D. In some embodiments, the hold call may be manually undone. In some embodiments, the transaction may be sent to a repair queue to attempt to repair the transaction so that it can be completed, as described elsewhere in this disclosure. If the hold call on the account was successful (step 9110, “yes” branch), then the hold call to the bank core is canceled (step 9114).

A call is made to a delete hold API (step 9116). After the call to the delete hold API (step 9116), a determination is made whether the transaction was successfully posted after the hold was removed from the account (step 9118). If the transaction was not successfully posted (step 9118, “no” branch), then an invalid posting message is created (step 9120) and the message is sent for real-time event capture (step 9122).

If the transaction was successfully posted (step 9118, “yes” branch), then a success status is returned (step 9124) and a determination is made whether the transaction can be moved to the ACH payment rail (step 9126). If the transaction cannot be moved to the ACH payment rail (step 9126, “no” branch), then a pain.002 reject message is sent to the channel (e.g., the initiating bank or fintech; step 9128). The method 9000 then proceeds to real-time event capture of the pain.002 reject message (step 9046) as described in connection with FIG. 9D.

After the pain.002 ACCC message is sent to the channel (step 9108, FIG. 9F), the method 9000 continues by posting the credit or debit to the bank core (step 9130). The bank core used to continue processing the transaction is determined from the routing number in the transaction (step 9132). In some embodiments, this bank core may be the same bank core as previously used; in other embodiments, it may be a different bank core. In some embodiments, the MMH may be configured to select which core is used to continue processing the transaction. A call is made to a post debit API (step 9134).

After the post debit API is called (step 9134), a determination is made whether the transaction was successfully posted (step 9136). If the transaction was not successfully posted (step 9136, “no” branch), then an invalid posting message is created (step 9138) and the message is sent for real-time event capture (step 9140).

If the transaction was successfully posted (step 9136, “yes” branch), then a success status is returned (step 9142). A camt.054 debit notification message is sent to the creditor bank (step 9144). A determination is made whether a remit message should be sent to the payment scheme, based on the data in the pain.001 message (step 9146). If the remit message should be sent (step 9146, “yes” branch), then a remt.001 message is sent to the payment scheme (step 9148). For example, the remt.001 message may include remittance details associated with a payment. If the remit message should not be sent (step 9146, “no” branch) or after the remt.001 message is sent (step 9148), the transaction has completed and the method 9000 terminates (step 9150).

After the real-time event capture after an invalid posting message (step 9122 in FIG. 9G or step 9140 in FIG. 9H), the transaction is stored for manual processing (step 9152). A manual update is performed (step 9154). As described elsewhere in this disclosure, the repair queue provides the ability to hold transactions for manual processing. The UX may be configured to allow the client (e.g., bank, fintech, or corporation) to manually submit the payment for processing. In the case of an ACH payment, this update will create the Nacha payment message.

A determination is made whether the transaction can be moved to the ACH payment rail (step 9156). If the transaction cannot be moved to the ACH payment rail (step 9156, “no” branch), then a pain.002 reject message is sent to the channel (e.g., the initiating bank or fintech; step 9158). The method 9000 then proceeds to real-time event capture of the pain.002 reject message (step 9046) as described in connection with FIG. 9D. If the transaction can be moved to the ACH payment rail (step 9156, “yes” branch), then the payment is posted to the bank core (step 9160). A camt.054 debit notification message is sent to the creditor bank (step 9144) and the method 9000 continues as described above.

After the Nacha file is prepared to be sent over the ACH payment rail for further processing (step 9036 in FIG. 9C) or after it is determined that the transaction can be moved to the ACH payment rail (step 9126, “yes” branch in FIG. 9G), a determination is made whether the transformed message (into the Nacha file) contains a valid originator (step 9162). If the transformed message does not contain a valid originator (step 9162, “no” branch), then the transaction is rejected (step 9164). A pain.002 reject message is sent to the channel (e.g., the initiating bank or fintech; step 9166) and the method 9000 then proceeds to real-time event capture of the pain.002 reject message (step 9046) as described in connection with FIG. 9D.

If the transformed message contains a valid originator (step 9162, “yes” branch), then a determination is made whether the transformed message is in a valid Nacha format (step 9168). If the transformed message is not in a valid Nacha format (step 9168, “no” branch), then the pain.001 message is transformed to a Nacha record (step 9170). For example, it may be assumed that the original transaction was a pain.001 message. The check here is to determine if the pain.001 message is able to verify that the client had the ability to originate an ACH transaction. If the client does not have the ability to originate an ACH transaction, the transaction may not proceed as an ACH transaction. If the client has the ability to originate an ACH transaction, then a pacs.008 message may be transformed to the ACH format (as all pain.001 messages may be transformed to pacs.008 messages for processing).

A determination is made whether the Nacha record can be added to the Nacha same-day window (step 9172). For example, the determination may include checking whether the message was received prior to a predetermined cut-off time for being included in the same-day window. If the Nacha record cannot be added to the Nacha same-day window (step 9172, “no” branch), a determination is made whether the message can be transformed from a real-time payment to an ACH format (step 9174). For example, this determination may include determining whether the client is a valid originator for an ACH transaction. If the message cannot be transformed into the ACH format (step 9174, “no” branch), then the transaction is rejected (step 9164) and the method 9000 continues as described above.

If the message can be transformed into the ACH format (step 9174, “yes” branch), then the transformed message is added to the Nacha file for next-day processing (step 9176) and the Nacha file is passed to a warehouse storage for standard ACH processing (step 9178).

If the Nacha record can be added to the Nacha same-day window (step 9172, “yes” branch), then the Nacha record is added to the Nacha file for same-day processing (step 9180).

After the Nacha file is passed to a warehouse storage for standard ACH processing (step 9178) or after the Nacha record is added to the Nacha file for same-day processing (step 9180), flow proceeds to a selector 9182 to determine whether the Nacha file can be processed via the TCH payment rail or via the FedNow payment rail. If the Nacha file can be processed via the TCH payment rail, the Nacha file is sent via the Nacha payment rail (step 9184) and the method 9000 terminates (step 9186). If the Nacha file can be processed via the FedNow payment rail, the Nacha file is sent via the FedNow payment rail (step 9188) and the method 9000 terminates (step 9186).

### Processing an Incoming Send Transaction Between Two Hub Member Accounts

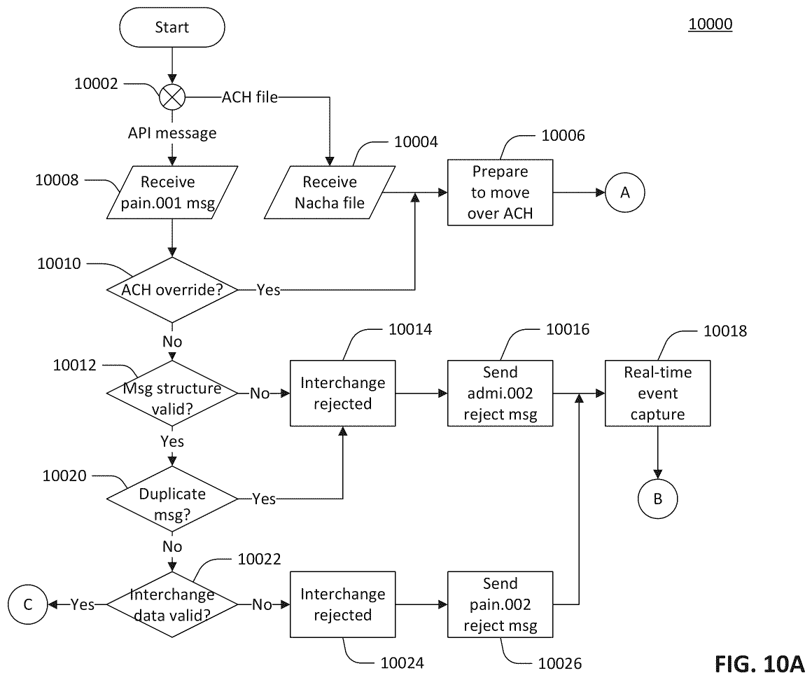

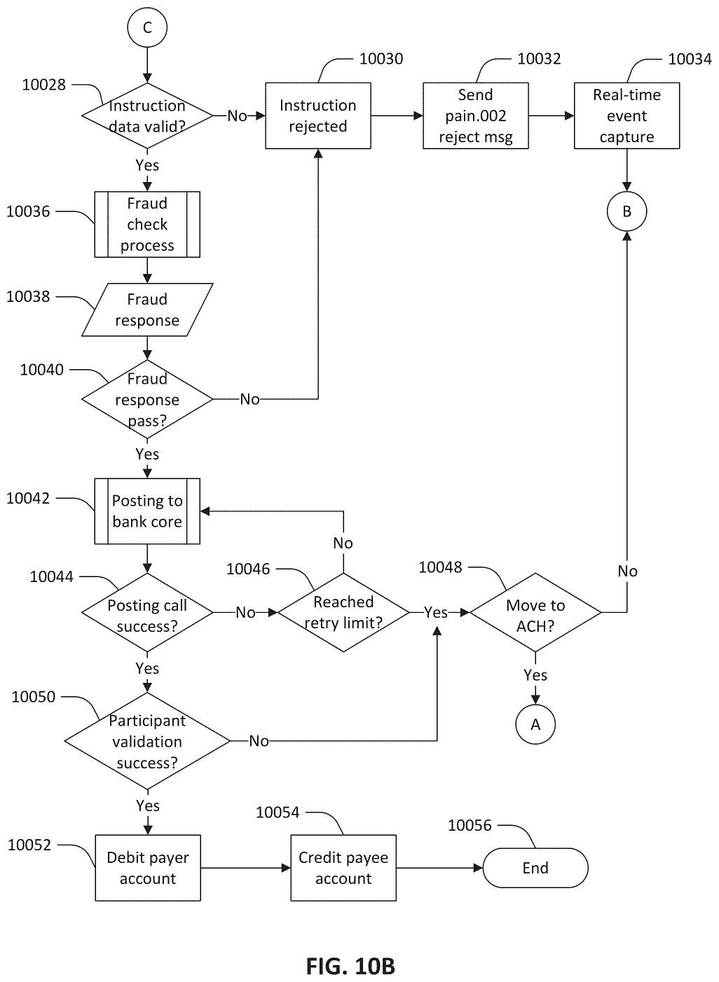

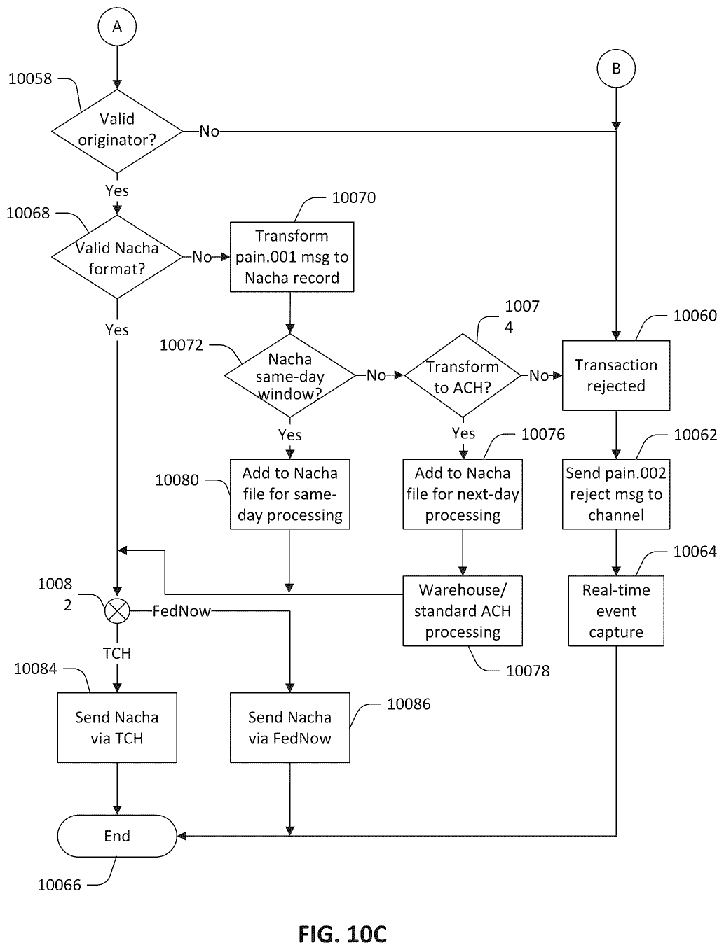

FIGS. 10A-10C are a flowchart of a method 10000 for processing an incoming send transaction between two hub member accounts, consistent with disclosed embodiments. The method 10000 may be used in situations where both the sending account and the receiving account belong to banks or fintechs that are hub members (both accounts do not need to be associated with the same financial institution). In such embodiments, the initial verification steps may be bypassed because both accounts have the necessary security and authorization checks to access the MMH. There are some additional differences in the flows as compared to FIGS. 9A-9J when both accounts belong to banks or fintechs that are hub members.

At selector 10002, a determination is made whether the transaction is in an ACH file or is an API message. If the transaction is an ACH file, it is received in a Nacha file format (step 10004). The Nacha file is prepared to be sent over the ACH payment rail for further processing (step 10006). The further processing for the Nacha file will be described at connector A in connection with FIG. 10C.

If the transaction is an API message, then it may be received as an ISO 20022 message, such as a pain.001 message (step 10008). The pain.001 message is a customer credit transfer initiation message and is sent to the debtor, to request funds to be moved from the debtor's account to the creditor's account.

A determination is made whether the transaction includes an indicator for an ACH override (step 10010). In some embodiments, even though the transaction is received as a pain.001 message, the sending financial institution may prefer to process the transaction as an ACH transaction instead of over a different payment rail. If the transaction includes an ACH override indicator (step 10010, “yes” branch), then a Nacha file is prepared to be sent over the ACH payment rail for further processing (step 10006) and the method 10000 continues as described above.

If the transaction does not include an ACH override indicator (step 10010, “no” branch), then a determination is made whether the pain.001 message has a valid message structure (step 10012). This is the first of several checks to examine the pain.001 message to ensure that it complies with the standard, contains correct information (e.g., no missing or transposed digits in an account number) and does not include any possibly fraudulent elements. If the pain.001 message structure is not valid (step 10012, “no” branch), then the message interchange is rejected (step 10014). An admi.002 rejection message is sent back to the transaction originator (step 10016). The admi.002 rejection message is an administrative-type message that is sent to a caller when the preceding message is rejected and may include a reason for the rejection. The rejection message is sent for real-time event capture (step 10018). The method 10000 continues at connector B as described in connection with FIG. 10C.

If the pain.001 message structure is valid (step 10012, “yes” branch), then a determination is made whether the pain.001 message is a duplicate message (step 10020). If the pain.001 message is a duplicate message (step 10020, “yes” branch), then the message interchange is rejected (step 10014) and the method 10000 continues with step 10016 as described above.

If the pain.001 message is not a duplicate message (step 10020, “no” branch), then a determination is made whether the interchange data in the pain.001 message is valid (step 10022). If the interchange data is not valid (step 10022, “no” branch), then the message interchange is rejected (step 10024). A pain.002 rejection message is sent back to the caller (e.g., the initiating bank or fintech; step 10026) and the method 10000 continues with step 10018 as described above.

If the interchange data in the pain. 001 message is valid (step 10022, “yes” branch), then a determination is made whether the instruction data in the pain.001 message is valid (step 10028). For example, the instruction data may include one of several different instruction types permitted in the pain.001 message format. If the instruction data in the pain.001 message is not valid (step 10028, “no” branch), then the instruction is rejected (step 10030). A pain.002 rejection message is sent back to the caller (e.g., the initiating bank or fintech; step 10032). The rejection message is sent for real-time event capture (step 10034). The method 10000 continues at connector B as described in connection with FIG. 10C.

If the instruction data in the pain.001 message is valid (step 10028, “yes” branch), then a fraud check process is performed (step 10036). The fraud check process returns a fraud response (step 10038). The fraud response is evaluated to determine whether the fraud check passed (step 10040). If the fraud check response does not pass (step 10040, “no” branch), then the instruction is rejected (step 10030) and the method 10000 continues at step 10032 as described above. In some embodiments, the fraud check response may not pass if the transaction includes a possible fraud indication identified during the fraud check process.

If the fraud check response passes (step 10040, “yes” branch), then the transaction is posted to the bank core (step 10042). A determination is made whether the transaction posting was successful (step 10044). If the transaction posting was not successful (step 10044, “no” branch), then a determination is made whether a retry limit on the transaction has been reached (step 10046). For example, the retry limit may be based on a predetermined period of time (e.g., five seconds) during which the MMH may attempt to post the transaction to the banking core within the predetermined period of time. As another example, the retry limit may be based on a number of attempted postings to the banking core (e.g., ten postings). If the retry limit has not been reached (step 10046, “no” branch), then the posting to the bank core is retried (step 10042).

If the retry limit has been reached (step 10046, “yes” branch), then a determination is made whether the transaction can be moved to the ACH payment rail to be completed (step 10048). For example, this determination may include determining whether the client is a valid originator for an ACH transaction. If the transaction cannot be moved to the ACH payment rail (step 10048, “no” branch), then the method 10000 continues at connector B as described in connection with FIG. 10C. If the transaction can be moved to the ACH payment rail (step 10048, “yes” branch), then the method 10000 continues at connector A as described in connection with FIG. 10C.

If the transaction posting was successful (step 10044, “yes” branch), then a determination is made whether the participant validation is successful (step 10050). For example, this check may determine whether both the debtor and the creditor indicated in the pain.001 message are valid parties. If the participant validation fails (step 10050, “no” branch), then a determination is made whether the transaction can be moved to the ACH payment rail to be completed (step 10048) and the method 10000 continues as described above. If the participant validation succeeds (step 10050, “yes” branch), then the payer's account is debited (step 10052), the payee's account is credited (step 10054), and the method terminates (step 10056).

After the Nacha file is prepared to be sent over the ACH payment rail for further processing (step 10006 in FIG. 10A) or after it is determined that the transaction can be moved to the ACH payment rail (step 10048, “yes” branch in FIG. 10B), a determination is made whether the transformed message (into the Nacha file) contains a valid originator (step 10058). If the transformed message does not contain a valid originator (step 10058, “no” branch), then the transaction is rejected (step 10060). A pain.002 reject message is sent to the channel (step 10062). The rejection message is sent for real-time event capture (step 10064) and the method 10000 terminates (step 10066).

After the real-time event capture (step 10018 in FIG. 10A), the real-time event capture (step 10034 in FIG. 10B), or if the transaction cannot be moved to the ACH payment rail (step 10048, “no” branch in FIG. 10B), the transaction is rejected (step 10060) and the method 10000 continues with step 10062 as described above.

If the transformed message contains a valid originator (step 10058, “yes” branch), then a determination is made whether the transformed message is in a valid Nacha format (step 10068). If the transformed message is not in a valid Nacha format (step 10068, “no” branch), then the pain.001 message is transformed to a Nacha record (step 10070).

A determination is made whether the Nacha record can be added to the Nacha same-day window (step 10072). For example, the determination may include checking whether the message was received prior to a predetermined cut-off time for being included in the same-day window. If the Nacha record cannot be added to the Nacha same-day window (step 10072, “no” branch), a determination is made whether the message can be transformed from a real-time payment to an ACH format (step 10074). If the message cannot be transformed into the ACH format (step 10074, “no” branch), then the transaction is rejected (step 10060) and the method 10000 continues as described above.

If the message can be transformed into the ACH format (step 10074, “yes” branch), then the transformed message is added to the Nacha file for next-day processing (step 10076) and the Nacha file is passed to a warehouse storage for standard ACH processing (step 10078).

If the Nacha record can be added to the Nacha same-day window (step 10072, “yes” branch), then the Nacha record is added to the Nacha file for same-day processing (step 10080).

After the Nacha file is passed to a warehouse storage for standard ACH processing (step 10078) or after the Nacha record is added to the Nacha file for same-day processing (step 10080), flow proceeds to a selector 10082 to determine whether the Nacha file can be processed via the TCH payment rail or via the FedNow payment rail. If the Nacha file can be processed via the TCH payment rail, the Nacha file is sent via the Nacha payment rail (step 10084) and the method 10000 terminates (step 10066). If the Nacha file can be processed via the FedNow payment rail, the Nacha file is sent via the FedNow payment rail (step 10086) and the method 10000 terminates (step 10066).

### Processing an Incoming Receive Transaction

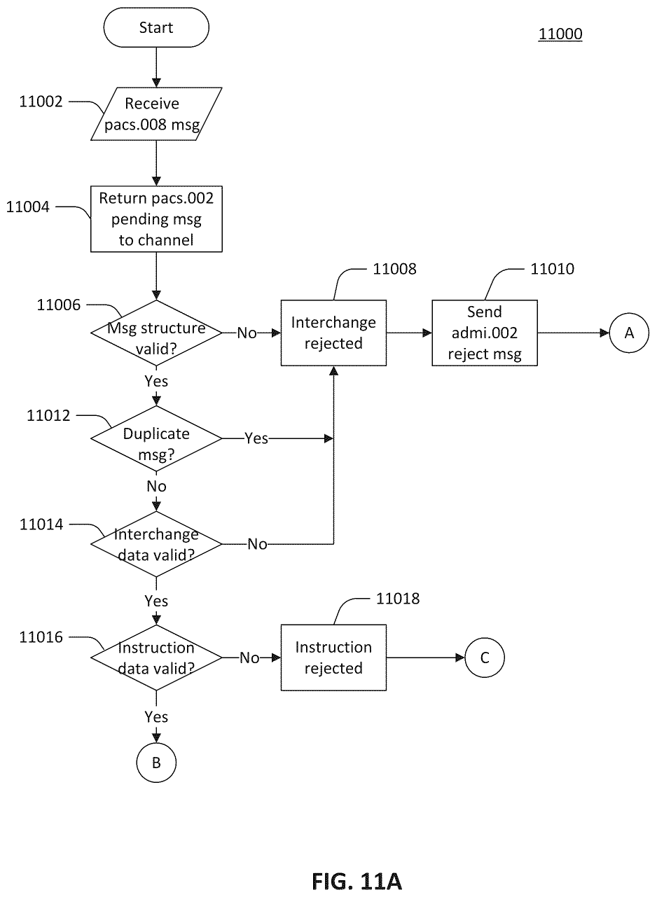

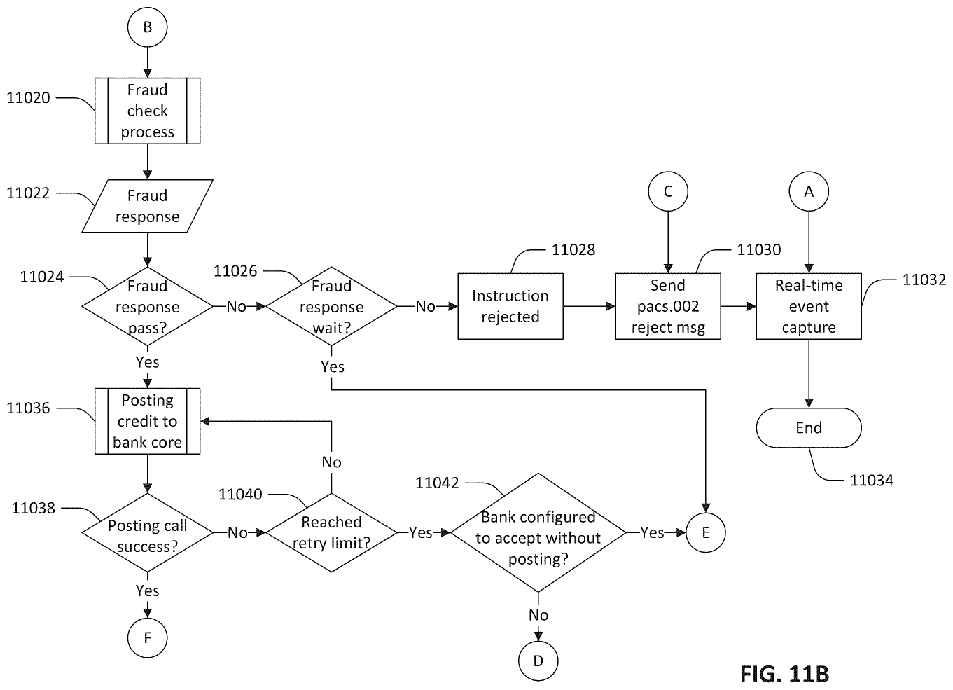

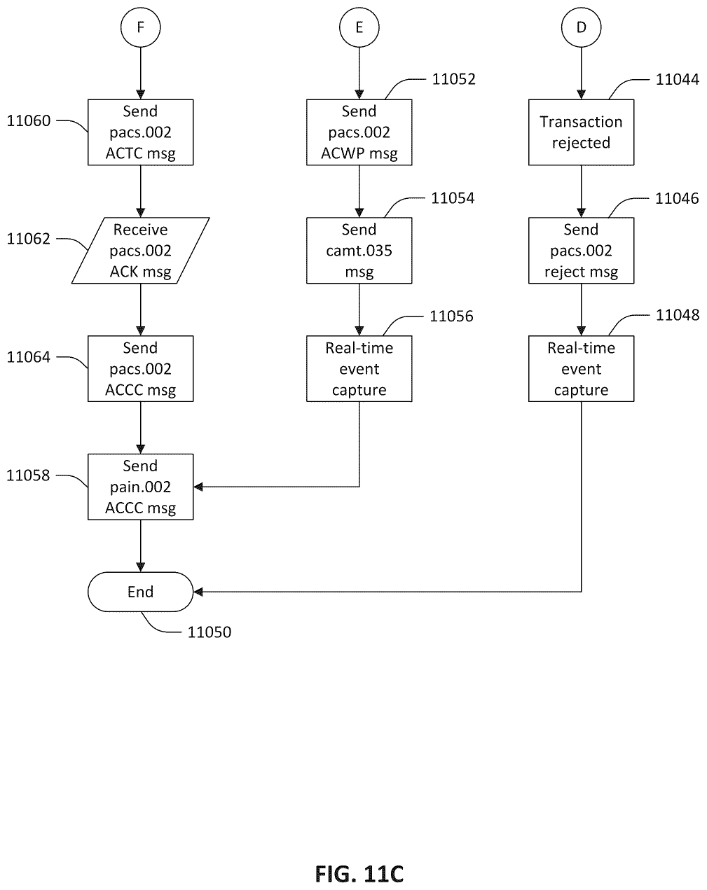

FIGS. 11A-11C are a flowchart of a method 11000 for processing an incoming receive transaction, consistent with disclosed embodiments. The MMH receives a transaction formatted as a pacs.008 message (step 11002). The pacs.008 message is a financial institution to financial institution customer credit transfer message and is sent by the debtor institution to the creditor institution, to move funds from the debtor to the creditor. A pacs.002 pending status message is sent to the channel (e.g., the initiating bank or fintech; step 11004). A pacs.002 message is a financial institution to financial institution payment status report message and includes status information about a previously sent message. In this instance, the pacs.002 message indicates a pending status for the transaction.

A determination is made whether the pacs.008 message has a valid message structure (step 11006). This is the first of several checks to examine the pacs.008 message to ensure that it complies with the standard, contains correct information (e.g., no missing or transposed digits in an account number) and does not include any possibly fraudulent elements. If the pacs.008 message structure is not valid (step 11006, “no” branch), then the message interchange is rejected (step 11008). An admi.002 rejection message is sent back to the transaction originator (step 11010). The admi.002 rejection message is an administrative-type message that is sent to a caller when the preceding message is rejected and may include a reason for the rejection. The method 11000 continues at connector A as described in connection with FIG. 11B.

If the pacs.008 message structure is valid (step 11006, “yes” branch), then a determination is made whether the pacs.008 message is a duplicate message (step 11012). If the pacs.008 message is a duplicate message (step 11012, “yes” branch), then the message interchange is rejected (step 11008) and the method 11000 continues with step 11010 as described above.

If the pacs.008 message is not a duplicate message (step 11012, “no” branch), then a determination is made whether the interchange data in the pacs.008 message is valid (step 11014). If the interchange data is not valid (step 11014, “no” branch), then the message interchange is rejected (step 11008) and the method 11000 continues with step 11010 as described above.

If the interchange data in the pacs.008 message is valid (step 11014, “yes” branch), then a determination is made whether the instruction data in the pacs.008 message is valid (step 11016). For example, the instruction data may include one of several different instruction types permitted in the pacs.008 message format. If the instruction data in the pacs.008 message is not valid (step 11016, “no” branch), then the instruction is rejected (step 11018). The method 11000 continues at connector C as described in connection with FIG. 11B.

If the instruction data in the pacs.008 message is valid (step 11016, “yes” branch), then a fraud check process is performed (step 11020). The fraud check process returns a fraud response (step 11022). The fraud response is evaluated to determine whether the fraud check passed (step 11024). In some embodiments, the fraud check response may not pass if the transaction includes a possible fraud indication identified during the fraud check process. If the fraud check response does not pass (step 11024, “no” branch), then a determination is made whether a fraud response wait has been applied (step 11026). For example, if the fraud check system cannot be reached, based on configuration from the client, the MMH may allow the transaction to be posted with a “research required” status or may reject the transaction with a “research required” status. If a fraud response wait has not been applied (step 11026, “no” branch), then the instruction is rejected (step 11028). A pacs.002 rejection message is sent (step 11030). The rejection message is sent for real-time event capture (step 11032) and the method terminates (step 11034).

If the fraud check response passes (step 11024, “yes” branch), then a credit is posted to the bank core (step 11036). A determination is made whether the credit posting was successful (step 11038). If the credit posting was not successful (step 11038, “no” branch), then a determination is made whether a retry limit on the transaction has been reached (step 11040). For example, the retry limit may be based on a predetermined period of time (e.g., five seconds) during which the MMH may attempt to post the credit to the banking core within the predetermined period of time. As another example, the retry limit may be based on a number of attempted postings to the banking core (e.g., ten postings). If the retry limit has not been reached (step 11040, “no” branch), then the credit posting to the bank core is retried (step 11036).

If the retry limit has been reached (step 11040, “yes” branch), then this is an indication that there may have been a technical failure in attempting to post the credit to the bank core. A determination is made whether the bank core is configured to accept the transaction without posting (step 11042). For example, if there is a technical issue with the bank core, the transaction may still be processed. As an example, the transaction may be held for later processing, to post the credit to the account. If the bank core is not configured to accept the transaction without posting (step 11042, “no” branch), then the transaction is rejected (step 11044). A pacs.002 rejection message is sent (step 11046). The rejection message is sent for real-time event capture (step 11048) and the method 11000 terminates (step 11050).

If the fraud response wait has been applied (step 11026, “yes” branch) or if the bank core is configured to accept the transaction without posting (step 11042, “yes” branch), then a pacs.002 ACWP (accept without posting) message is sent to the channel (e.g., the initiating bank or fintech; step 11052). A camt.035 message for payment acknowledgement is sent (step 11054), to indicate payment acceptance following posting (for example, after a fraud release and posting process). The acknowledgement message is sent for real-time event capture (step 11056). A pain.002 accepted settlement completed (ACCC) message is sent to the channel (e.g., the initiating bank or fintech; step 11058) and the method 11000 terminates (step 11050).

If the posting call was successful (step 11038, “yes” branch), then a pacs.002 ACTC message is sent to the channel (e.g., the initiating bank or fintech; step 11060). A pacs.002 acknowledgement (ACK) message is received from the channel (e.g., the initiating bank or fintech; step 11062). A pacs.002 accepted settlement completed (ACCC) message is sent to the channel (e.g., the initiating bank or fintech; step 11064) and the method 11000 continues with step 11058 as described above.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer programs based on the written description and methods of this specification are within the skill of a software developer. The various functions, scripts, programs, or modules can be created using a variety of programming techniques. For example, computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages (including an object oriented programming language and/or conventional procedural programming language) such as Smalltalk, JAVASCRIPT, C, C++, JAVA, PHP, PYTHON, RUBY, PERL, BASH, or other programming or scripting languages. One or more of such software sections or modules can be integrated into a computer system, non-transitory computer readable media, or existing communications software. The programs, modules, or code can also be implemented or replicated as firmware or circuit logic. The computer readable program instructions may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

These computer readable program instructions may be provided to a processor of a general-purpose computer, special-purpose computer, or other programmable data processing apparatus, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

The flowcharts and block diagrams in the Figures illustrate the architecture, functionality, and operation of possible implementations of systems, methods, and computer program products according to various embodiments of the present disclosure. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Moreover, some blocks may be executed iteratively for any number of iterations, and some blocks may not be executed at all. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments may further be described using the following clauses:

1. A method for payment transaction monitoring in a real-time payments system, including:
receiving a payment transaction;
assigning an identifier to the payment transaction;
associating an event with the identifier at each step of processing the payment transaction;
recording the event with the identifier in real-time as the event occurs;
monitoring the events in real-time to determine whether a payment transaction stop condition exists; and
stopping processing of the payment transaction on a condition that the payment transaction stop condition exists.

2. The method of clause 1, wherein the identifier is a unique identifier associated with the payment transaction from payment transaction initiation through payment transaction termination.

3. The method of clause 2, wherein payment transaction termination includes completing processing the payment transaction.

4. The method of clause 2, wherein payment transaction termination includes stopping processing of the payment transaction based on the payment transaction stop condition.

5. The method of any one of clauses 1-4, wherein the event includes a status update at a step of processing the payment transaction.

6. The method of any one of clauses 1-5, wherein recording the event includes storing the event in a storage system.

7. The method of any one of clauses 1-6, wherein monitoring the events includes performing real-time analytics on the events to determine if a stop condition is detected.

8. The method of any one of clauses 1-7, wherein monitoring the events is performed by a trained machine learning model.

9. A system for payment transaction monitoring in a real-time payments system, including:
at least one processor; and
at least one memory containing instructions that, when executed by the at least one processor, cause the at least one processor to perform a method including:
   receiving a payment transaction;
   assigning an identifier to the payment transaction;
   associating an event with the identifier at each step of processing the payment transaction;
   recording the event with the identifier in real-time as the event occurs;
   monitoring the events in real-time to determine whether a payment transaction stop condition exists; and
   stopping processing of the payment transaction on a condition that the payment transaction stop condition exists.

10. The system of clause 9, wherein the identifier is a unique identifier associated with the payment transaction from payment transaction initiation through payment transaction termination.

11. The system of clause 10, wherein payment transaction termination includes completing processing the payment transaction.

12. The system of clause 10, wherein payment transaction termination includes stopping processing of the payment transaction based on the payment transaction stop condition.

13. The system of any one of clauses 9-12, wherein the event includes a status update at a step of processing the payment transaction.

14. The system of any one of clauses 9-13, wherein recording the event includes storing the event in a storage system.

15. The system of any one of clauses 9-14, wherein monitoring the events includes performing real-time analytics on the events to determine if a stop condition is detected.

16. The system of any one of clauses 9-15, wherein monitoring the events is performed by a trained machine learning model.

17. A non-transitory computer-readable medium including instructions that when executed by at least one processor cause the at least one processor to perform a method including:
receiving a payment transaction;
assigning an identifier to the payment transaction;
associating an event with the identifier at each step of processing the payment transaction;
recording the event with the identifier in real-time as the event occurs;
monitoring the events in real-time to determine whether a payment transaction stop condition exists; and
stopping processing of the payment transaction on a condition that the payment transaction stop condition exists.

18. The non-transitory computer-readable medium of clause 17, wherein the identifier is a unique identifier associated with the payment transaction from payment transaction initiation through payment transaction termination.

19. The non-transitory computer-readable medium of clause 18, wherein payment transaction termination includes completing processing the payment transaction.

20. The non-transitory computer-readable medium of clause 18, wherein payment transaction termination includes stopping processing of the payment transaction based on the payment transaction stop condition.

21. The non-transitory computer-readable medium of any one of clauses 17-20, wherein the event includes a status update at a step of processing the payment transaction.

22. The non-transitory computer-readable medium of any one of clauses 17-21, wherein recording the event includes storing the event in a storage system.

23. The non-transitory computer-readable medium of any one of clauses 17-22, wherein monitoring the events includes performing real-time analytics on the events to determine if a stop condition is detected.

24. The non-transitory computer-readable medium of any one of clauses 17-23, wherein monitoring the events is performed by a trained machine learning model.

25. A method for routing a payment transaction in a real-time payments system, including:
receiving the payment transaction;
examining contents of the payment transaction, wherein the contents of the payment transaction includes a transaction type;
examining metadata associated with the payment transaction, wherein the metadata includes a payment rail preference;
determining whether the payment transaction is formatted to match a format of the payment rail preference;
reformatting the payment transaction to match the format of the payment rail preference on a condition that the payment transaction is not in the format of the payment rail preference; and
routing the payment transaction to the payment rail for processing.

26. The method of clause 25, further including:
determining whether the payment rail preference matches a payment rail associated with the transaction type; and
reformatting the payment transaction to match the format of the payment rail preference on a condition that the payment rail associated with the transaction type does not match the payment rail preference.

27. The method of clauses 25 or 26, wherein the payment rail preference includes a payment rail having a lowest cost based on the transaction type.

28. The method of any one of clauses 25-27, wherein the payment rail preference includes a payment rail having a shortest completion time based on the transaction type.

29. The method of any one of clauses 25-28, wherein the payment rail preference includes a caller-preferred route.

30. The method of any one of clauses 25-29, wherein the payment rail preference is based on a type of caller.

31. The method of clause 30, wherein the caller is one of a bank, a fintech, or a corporation.

32. The method of any one of clauses 25-31, further including:
training a decision-type machine learning model based on previous routes for a given transaction type; and
using the trained machine learning model to determine a payment rail for routing the payment transaction based on the transaction type and the payment rail preference.

33. The method of clause 32, wherein the trained machine learning model is configured to reformat the payment transaction to match a format of the determined payment rail.

34. A system for routing a payment transaction in a real-time payments system, including:
at least one processor; and
at least one memory containing instructions that, when executed by the at least one processor, cause the at least one processor to perform a method including:
   receiving the payment transaction;
   examining contents of the payment transaction, wherein the contents of the payment transaction includes a transaction type;
   examining metadata associated with the payment transaction, wherein the metadata includes a payment rail preference;
   determining whether the payment transaction is formatted to match a format of the payment rail preference;
   reformatting the payment transaction to match the format of the payment rail preference on a condition that the payment transaction is not in the format of the payment rail preference; and
   routing the payment transaction to the payment rail for processing.

35. The system of clause 34, wherein the instructions further include:
determining whether the payment rail preference matches a payment rail associated with the transaction type; and
reformatting the payment transaction to match the format of the payment rail preference on a condition that the payment rail associated with the transaction type does not match the payment rail preference.

36. The system of clauses 34 or 35, wherein the payment rail preference includes a payment rail having a lowest cost based on the transaction type.

37. The system of any one of clauses 34-36, wherein the payment rail preference includes a payment rail having a shortest completion time based on the transaction type.

38. The system of any one of clauses 34-37, wherein the payment rail preference includes a caller-preferred route.

39. The system of any one of clauses 34-38, wherein the payment rail preference is based on a type of caller.

40. The system of clause 39, wherein the caller is one of a bank, a fintech, or a corporation.

41. The system of any one of clauses 34-40, wherein the instructions further include:
training a decision-type machine learning model based on previous routes for a given transaction type; and
using the trained machine learning model to determine a payment rail for routing the payment transaction based on the transaction type and the payment rail preference.

42. The system of clause 41, wherein the trained machine learning model is configured to reformat the payment transaction to match a format of the determined payment rail.

43. A non-transitory computer-readable medium including instructions that
when executed by at least one processor cause the at least one processor to perform a method including:
receiving the payment transaction;
examining contents of the payment transaction, wherein the contents of the payment transaction includes a transaction type;
examining metadata associated with the payment transaction, wherein the metadata includes a payment rail preference;
determining whether the payment transaction is formatted to match a format of the payment rail preference;
reformatting the payment transaction to match the format of the payment rail preference on a condition that the payment transaction is not in the format of the payment rail preference; and
routing the payment transaction to the payment rail for processing.

44. The non-transitory computer-readable medium of clause 43, further including:
determining whether the payment rail preference matches a payment rail associated with the transaction type; and
reformatting the payment transaction to match the format of the payment rail preference on a condition that the payment rail associated with the transaction type does not match the payment rail preference.

45. The non-transitory computer-readable medium of clauses 43 or 44, wherein the payment rail preference includes a payment rail having a lowest cost based on the transaction type.

46. The non-transitory computer-readable medium of any one of clauses 43-45, wherein the payment rail preference includes a payment rail having a shortest completion time based on the transaction type.

47. The non-transitory computer-readable medium of any one of clauses 43-46, wherein the payment rail preference includes a caller-preferred route.

48. The non-transitory computer-readable medium of any one of clauses 43-47, wherein the payment rail preference is based on a type of caller.

49. The non-transitory computer-readable medium of clause 48, wherein the caller is one of a bank, a fintech, or a corporation.

50. The non-transitory computer-readable medium of any one of clauses 43-49, further including:
training a decision-type machine learning model based on previous routes for a given transaction type; and
using the trained machine learning model to determine a payment rail for routing the payment transaction based on the transaction type and the payment rail preference.

51. The non-transitory computer-readable medium of clause 50, wherein the trained machine learning model is configured to reformat the payment transaction to match a format of the determined payment rail.

52. A method for repairing a payment transaction in a real-time payments system, including:
receiving the payment transaction;
examining contents of the payment transaction, wherein the contents of the payment transaction includes a transaction type;
examining metadata associated with the payment transaction, wherein the metadata includes a payment rail preference;
repairing the payment transaction by:
   examining an error code associated with the payment transaction; and
   performing a repair operation on the payment transaction based on the error code; and
routing the payment transaction to the payment rail for processing.

53. The method of clause 52, wherein the repair operation includes retrying to post the payment transaction at a later point in time.

54. The method of clauses 52 or 53, wherein the repair operation includes editing one or more elements of the contents of the payment transaction.

55. The method of any one of clauses 52-54, wherein the repair operation includes editing one or more elements of the metadata associated with the payment transaction.

56. The method of any one of clauses 52-55, wherein the repair operation includes sending the payment transaction to a data enrichment component for repair.

57. The method of clause 56, wherein the data enrichment component is configured to edit one or more elements of the contents of the payment transaction.

58. The method of clause 56, wherein the data enrichment component is configured to edit one or more elements of the metadata associated with the payment transaction.

59. A system for repairing a payment transaction in a real-time payments system, including:
at least one processor; and
at least one memory containing instructions that, when executed by the at least one processor, cause the at least one processor to perform a method including:
   receiving the payment transaction;
   examining contents of the payment transaction, wherein the contents of the payment transaction includes a transaction type;
   examining metadata associated with the payment transaction, wherein the metadata includes a payment rail preference;
   repairing the payment transaction by:
      examining an error code associated with the payment transaction; and
      performing a repair operation on the payment transaction based on the error code; and
   routing the payment transaction to the payment rail for processing.

60. The system of clause 59, wherein the repair operation includes retrying to post the payment transaction at a later point in time.

61. The system of clauses 59 or 60, wherein the repair operation includes editing one or more elements of the contents of the payment transaction.

62. The system of any one of clauses 59-61, wherein the repair operation includes editing one or more elements of the metadata associated with the payment transaction.

63. The system of any one of clauses 59-62, wherein the repair operation includes sending the payment transaction to a data enrichment component for repair.

64. The system of clause 63, wherein the data enrichment component is configured to edit one or more elements of the contents of the payment transaction.

65. The system of clause 63, wherein the data enrichment component is configured to edit one or more elements of the metadata associated with the payment transaction.

66. A non-transitory computer-readable medium including instructions that when executed by at least one processor cause the at least one processor to perform a method including:
receiving the payment transaction;
examining contents of the payment transaction, wherein the contents of the payment transaction includes a transaction type;
examining metadata associated with the payment transaction, wherein the metadata includes a payment rail preference;
repairing the payment transaction by:
   examining an error code associated with the payment transaction; and
   performing a repair operation on the payment transaction based on the error code; and
routing the payment transaction to the payment rail for processing.

67. The non-transitory computer-readable medium of clause 66, wherein the repair operation includes retrying to post the payment transaction at a later point in time.

68. The non-transitory computer-readable medium of clauses 66 or 67, wherein the repair operation includes editing one or more elements of the contents of the payment transaction.

69. The non-transitory computer-readable medium of any one of clauses 66-68, wherein the repair operation includes editing one or more elements of the metadata associated with the payment transaction.

70. The non-transitory computer-readable medium of any one of clauses 66-69, wherein the repair operation includes sending the payment transaction to a data enrichment component for repair.

71. The non-transitory computer-readable medium of clause 70, wherein the data enrichment component is configured to edit one or more elements of the contents of the payment transaction.

72. The non-transitory computer-readable medium of clause 70, wherein the data enrichment component is configured to edit one or more elements of the metadata associated with the payment transaction.

73. A method for processing a payment transaction in a real-time payments system, including:
receiving the payment transaction in a first format;
reformatting the payment transaction into a second format;
processing the payment transaction by the real-time payments system in the second format;
reformatting the payment transaction into a third format; and
sending the payment transaction in the third format to a payment rail for additional processing.

74. The method of clause 73, wherein:
the second format is a different format than the first format; and
the third format is a different format than the second format.

75. A system for processing a payment transaction in a real-time payments system, including:
at least one processor; and
at least one memory containing instructions that, when executed by the at least one processor, cause the at least one processor to perform a method including:
   receiving the payment transaction in a first format;
   reformatting the payment transaction into a second format;
   processing the payment transaction by the real-time payments system in the second format;
   reformatting the payment transaction into a third format; and
   sending the payment transaction in the third format to a payment rail for additional processing.

76. The system of clause 75, wherein:
the second format is a different format than the first format; and
the third format is a different format than the second format.

77. A non-transitory computer-readable medium including instructions that when executed by at least one processor cause the at least one processor to perform a method including:
receiving the payment transaction in a first format;
reformatting the payment transaction into a second format;
processing the payment transaction by the real-time payments system in the second format;
reformatting the payment transaction into a third format; and
sending the payment transaction in the third format to a payment rail for additional processing.

78. The non-transitory computer-readable medium of clause 77, wherein:
the second format is a different format than the first format; and
the third format is a different format than the second format.

79. A real-time payments system, including:
an application programming interface endpoint component configured to receive a payment transaction;
a payment orchestration component configured to process the payment transaction in the real-time payments system;
a routing component configured to route the payment transaction from the real-time payments system to a payment rail to complete processing of the payment transaction;
a repair component configured to implement a trained machine learning model to repair the payment transaction such that the payment transaction can continue to be processed by the payment orchestration component or by the payment rail;
a data enrichment component configured to edit one or more elements of the payment transaction; and
a reformatting component configured to reformat the payment transaction to a different format.

80. The real-time payments system of clause 79, wherein the routing component is configured to implement a trained machine learning model to route the payment transaction to the payment rail.

81. The real-time payments system of clauses 79 or 80, wherein the data enrichment component is further configured to edit one or more elements of metadata associated with the payment transaction.

82. The real-time payments system of any one of clauses 79-81, wherein:
the reformatting component is configured to reformat the payment transaction from a first format when the payment transaction is received by the application programming interface endpoint component to a second format used by the real-time payments system; and
the second format is a different format than the first format.

83. The real-time payments system of clause 82, wherein:
the reformatting component is further configured to reformat the payment transaction from the second format to a third format;
the third format is used by the payment rail; and
the third format is a different format than the second format.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments unless the embodiment is inoperative without those elements.

Moreover, while exemplary embodiments have been described herein, these have been presented for purposes of illustration, but are not intended to be exhaustive or limited to the embodiments disclosed, such that the scope includes any and all embodiments having equivalent elements, modifications, variations, omissions, combinations (e.g., of aspects across various embodiments), adaptations or alterations, without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as examples only, with a true scope being indicated by the following claims and their full scope of equivalents.

1.-72. (canceled)

73. A method for processing a payment transaction in a real-time payments system, comprising:
receiving the payment transaction in a first format;
reformatting the payment transaction into a second format;
processing the payment transaction by the real-time payments system in the second format;
reformatting the payment transaction into a third format; and
sending the payment transaction in the third format to a payment rail for additional processing.

74. The method of claim 73, wherein:
the second format is a different format than the first format; and
the third format is a different format than the second format.

75. A system for processing a payment transaction in a real-time payments system, comprising:
at least one processor; and
at least one memory containing instructions that, when executed by the at least one processor, cause the at least one processor to perform a method comprising:
receiving the payment transaction in a first format;
reformatting the payment transaction into a second format;
processing the payment transaction by the real-time payments system in the second format;
reformatting the payment transaction into a third format; and
sending the payment transaction in the third format to a payment rail for additional processing.

76. The system of claim 75, wherein:
the second format is a different format than the first format; and
the third format is a different format than the second format.

77. A non-transitory computer-readable medium comprising instructions that when executed by at least one processor cause the at least one processor to perform a method comprising:
receiving the payment transaction in a first format;
reformatting the payment transaction into a second format;
processing the payment transaction by the real-time payments system in the second format;
reformatting the payment transaction into a third format; and
sending the payment transaction in the third format to a payment rail for additional processing.

78. The non-transitory computer-readable medium of claim 77, wherein:
the second format is a different format than the first format; and
the third format is a different format than the second format.

79.-83. (canceled)

84. The method of claim 73, wherein the third format is a same format as the first format.

85. The method of claim 73, wherein reformatting the payment transaction into the third format includes:
examining contents of the payment transaction, wherein the contents of the payment transaction includes a transaction type;
examining metadata associated with the payment transaction, wherein the metadata includes a payment rail preference; and
reformatting the payment transaction to match the format of the payment rail preference on a condition that the payment transaction is not in the format of the payment rail preference.

86. The method of claim 85, further comprising:
determining whether the payment rail preference matches a payment rail associated with the transaction type; and
reformatting the payment transaction to match the format of the payment rail preference on a condition that the payment rail associated with the transaction type does not match the payment rail preference.

87. The method of claim 85, wherein the payment rail preference includes any one of:
a payment rail having a lowest cost based on the transaction type;
a payment rail having a shortest completion time based on the transaction type; or
a caller-preferred route.

88. The method of claim 85, wherein reformatting the payment transaction into the third format includes:
training a decision-type machine learning model based on previous routes for a given transaction type; and
using the trained machine learning model to determine a payment rail for routing the payment transaction based on the transaction type and the payment rail preference.

89. The system of claim 75, wherein the third format is a same format as the first format.

90. The system of claim 75, wherein reformatting the payment transaction into the third format includes:
examining contents of the payment transaction, wherein the contents of the payment transaction includes a transaction type;
examining metadata associated with the payment transaction, wherein the metadata includes a payment rail preference; and
reformatting the payment transaction to match the format of the payment rail preference on a condition that the payment transaction is not in the format of the payment rail preference.

91. The system of claim 90, further comprising:
determining whether the payment rail preference matches a payment rail associated with the transaction type; and
reformatting the payment transaction to match the format of the payment rail preference on a condition that the payment rail associated with the transaction type does not match the payment rail preference.

92. The system of claim 90, wherein the payment rail preference includes any one of:
a payment rail having a lowest cost based on the transaction type;
a payment rail having a shortest completion time based on the transaction type; or
a caller-preferred route.

93. The system of claim 90, wherein reformatting the payment transaction into the third format includes:
training a decision-type machine learning model based on previous routes for a given transaction type; and
using the trained machine learning model to determine a payment rail for routing the payment transaction based on the transaction type and the payment rail preference.

94. The non-transitory computer-readable medium of claim 77, wherein the third format is a same format as the first format.

95. The non-transitory computer-readable medium of claim 77, wherein reformatting the payment transaction into the third format includes:
examining contents of the payment transaction, wherein the contents of the payment transaction includes a transaction type;
examining metadata associated with the payment transaction, wherein the metadata includes a payment rail preference; and
reformatting the payment transaction to match the format of the payment rail preference on a condition that the payment transaction is not in the format of the payment rail preference.

96. The non-transitory computer-readable medium of claim 95, further comprising:
determining whether the payment rail preference matches a payment rail associated with the transaction type; and
reformatting the payment transaction to match the format of the payment rail preference on a condition that the payment rail associated with the transaction type does not match the payment rail preference,
wherein the payment rail preference includes any one of:
a payment rail having a lowest cost based on the transaction type;
a payment rail having a shortest completion time based on the transaction type; or
a caller-preferred route.

97. The non-transitory computer-readable medium of claim 95, wherein reformatting the payment transaction into the third format includes:
training a decision-type machine learning model based on previous routes for a given transaction type; and
using the trained machine learning model to determine a payment rail for routing the payment transaction based on the transaction type and the payment rail preference.
